(19) United States
(12) Patent Application Publication
(10) Pub. No.: US 2009/0070468 A1
(43) Pub. Date: Mar. 12, 2009

(54) COMMUNICATION SYSTEM AND COMMUNICATION METHOD

(75) Inventor: Yoshitaka Ohta, Osaka (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka (JP)

(21) Appl. No.: 12/160,284

(22) PCT Filed: Dec. 26, 2006
(86) PCT No.: PCT/JP2006/325869

§ 371 Date: Jul. 10, 2008

(30) Foreign Application Priority Data
Jan. 10, 2006 (JP) 2006-002479

(51) Int. Cl. G06F 15/173

(52) U.S. Cl. 709/226

(57) ABSTRACT

In a case where a first relay device 200 receives a first band allocation request and a second band allocation request in listed order, the first relay device 200 does not reserve bandwidth requested by the second band allocation request if flow information of the first band allocation request is given priority over flow information of the second band allocation request. In a case where a second relay device 300 receives the second band allocation request and the first band allocation request in listed order, the second relay device 300 reserves bandwidth requested by the first band allocation request if the flow information of the first band allocation request is given priority over the flow information of the second band allocation request.

### TECHNICAL FIELD

The present invention relates to a communication system where a data transmission terminal and a data reception terminal, which are interconnected via a network of wired or wireless lines, perform transmission/reception of data with each other. The present invention especially relates to technology for setting Quality of Service (QoS) that guarantees the quality of transmission during data transmission.

### BACKGROUND ART

RSVP (Resource reSerVation Protocol) is known as a protocol for ensuring the quality of communication by, on the network, reserving bandwidth of a communications channel connecting a transmission-source device and a transmission-destination device.

According to RSVP, a device that transmits data (the data transmission terminal) transmits a PATH message to a device that receives the data (the data reception terminal). The path message is a message output by the data transmission terminal to reserve a path through which the data transmission terminal transmits requested data to the data reception terminal. The PATH message includes information such as a bandwidth requirement, traffic characteristics and address information (IP addresses of the data transmission terminal and the data reception terminal, or the like).

The bandwidth requirement, which is included in the PATH message transmitted by the data transmission terminal bound for the data reception terminal, is rewritten in each relay device (e.g., router). At the same time, IP addresses of the relay devices are also written into the PATH message.

Upon receiving the PATH message, the data reception terminal transmits a RESV message to the data transmission terminal. The RESV message is a message output by the data reception terminal to reserve bandwidth of the path through which the data transmission terminal transmits the requested data to the data reception terminal. The RESV message includes information such as bandwidth to be actually reserved, a required service level and address information (the IP address of the data transmission terminal or the like).

The RESV message, which has been transmitted by the data reception terminal bound for the data transmission terminal, is returned to the data transmission terminal by following the path that the PATH message took in the reverse direction. Each relay device (e.g., router) that relayed the RESV message reserves the bandwidth included in the RESV message.

With RSVP, the data transmission terminal transmits the PATH message to the data reception terminal. Upon receiving the PATH message, the data reception terminal transmits, in response, the RESV message to the data transmission terminal. In this manner, RSVP makes the data reception terminal that transmits the RESV message perform an actual bandwidth reservation. Therefore, RSVP is suitable for a multicast communication that reflects the quality requested by the data reception terminal.

[Non-Patent Document 1]

RFC 2205 Resource reservation Protocol (RSVP)

### DISCLOSURE OF THE INVENTION

### The Problems the Invention is Going to Solve

Today's hard disc recorder with a networking capability can function not only as a data transmission terminal, sending a video stream to a data reception terminal, but also as a data reception terminal, receiving a video stream from another data transmission terminal.

The data transmission terminal acknowledges the data rate of the video stream to be transmitted therefrom to the data reception terminal. The data transmission terminal also acknowledges whether or not the data rate can be changed. For these reasons, it is preferable in some cases that the bandwidth reservation be made by the data transmission terminal, rather than by the data reception terminal.

Taking the above into consideration, assume a case where the data transmission terminal and the data reception terminal are configured such that they both can make the bandwidth reservation. The following describes an operation sequence pertaining to this case, with reference to FIG. 13. FIG. 13 shows an operation sequence pertaining to a case where the data transmission terminal makes a bandwidth reservation.

A data transmission terminal 4000 generates a band-allocation-request packet that requests bandwidth b1 (Step S1001), and outputs the generated band-allocation-request packet to a second relay device 3000 (Step S1002). The second relay device 3000 reserves the bandwidth b1 as requested by the band-allocation-request packet (Step S1003) and transfers the band-allocation-request packet to a first relay device 2000 (Step S1004).

The first relay device 20000 reserves the bandwidth b1 as requested by the band-allocation-request packet (Step S1005), and transfers the band-allocation-request packet to a data reception terminal 1000 (Step 1006).

Upon receiving the band-allocation-request packet, the data reception terminal 1000 identifies that the bandwidth b1 has been reserved by the first relay device 2000 and the second relay device 3000 (Step S1007). Then, in response to the band-allocation-request packet, a band-allocation-response packet is transferred from the data reception terminal 1000 to the first relay device 2000, from the first relay device 2000 to the second relay device 3000, and from the second relay device 3000 to the data transmission terminal 4000 (Steps S1008, S1009 and S1010).

Upon receiving the band-allocation-response packet, the data transmission terminal 4000 acknowledges that the bandwidth b1 has been reserved by the first relay device 2,000 and the second relay device 3000 (Step S1011). Henceforth, the data transmission terminal 4000 transmits data, such as a video stream, to the data reception terminal 1000 using the bandwidth b1.

However, in a case where the data transmission terminal 4000 and the data reception terminal 1000 are configured such that both of them can not only make but also cancel the bandwidth reservation, the following problems arise. Note, the following is based on the assumption that the first relay device 2000 and the second relay device 3000 are interconnected via the data transmission terminal 4000 and the data reception terminal 1000 therebetween.

The first problem is that, if the data transmission terminal 4000 and the data reception terminal 1000 reserve different bandwidths almost at the same time, the bandwidth to be eventually allocated by the first relay device 2000 would be different from that to be eventually allocated by the second relay device 3000.

The second problem is that, if the data transmission terminal 4000 requests a bandwidth allocation and the data reception terminal 1000 requests cancellation of a bandwidth allocation almost at the same time, it will end up in a situation where one of the first relay device 2000 and the second relay device 3000 cancels the bandwidth reservation whereas the other reserves the bandwidth.

The first problem is discussed below with reference to FIG. 14. FIG. 14 shows a sequence diagram illustrating a case where the data transmission terminal and the data reception terminal reserve different bandwidths.

The data reception terminal 1000 generates a first band-allocation-request packet that includes information such as bandwidth r1 to be requested (Step S1101), and outputs the generated first band-allocation-request packet to the first relay device 2000 (Step S1102). The first relay device 2000 reserves the bandwidth r1 as requested by the first band-allocation-request packet (Step S1103) and transfers the first band-allocation-request packet to the second relay device 3000 (Step S1104).

In the meantime, the data transmission terminal 4000 generates a second band-allocation-request packet that includes information such as bandwidth s1 to be requested (Step S1105), and transfers the generated second band-allocation-request packet to the second relay device 3000 (Step S1106). The second relay device 3000 reserves the bandwidth s1 as requested by the second band-allocation-request packet (Step S1107) and transfers the second band-allocation-request to the first relay device 2000 (Step S1108).

After reserving the bandwidth s1 as requested by the second band-allocation-request packet, the second relay device 3000 reserves the bandwidth r1 as requested by the first band-allocation-request packet received from the first relay device 2000 (Step S1109). The second relay device 3000 then transfers the first band-allocation-request packet to the data transmission terminal 4000 (Step S1110).

Upon receiving the first band-allocation-request packet, the data transmission terminal 4000 acknowledges that the bandwidth r1 has been reserved by the first relay device 2000 and the second relay device 3000 (Step S1111).

After reserving the bandwidth r1 as requested by the first band-allocation-request packet, the first relay device 2000 reserves the bandwidth s1 as requested by the second band-allocation-request packet received from the second relay device 3000 (Step S1112). The first relay device 2000 then transfers the second band-allocation-request packet to the data reception terminal 1000 (Step S1113).

Upon receiving the second band-allocation-request packet, the data reception terminal 1000 acknowledges that the bandwidth s1 has been reserved by the first relay device 2000 and the second relay device 3000 (Step S1114).

In response to the first band-allocation-request packet, a first band-allocation-response packet is transferred from the data transmission terminal 4000 to the second relay device 3000, from the second relay device 3000 to the first relay device 2000, and from the first relay device 2000 to the data reception terminal 1000 (Steps S1115, S1116 and S1117).

Upon receiving the first band-allocation-response packet, the data reception terminal 1000 acknowledges that the bandwidth r1 has been reserved by the first relay device 2000 and the second relay device 3000 (Step S1118).

In response to the second band-allocation-request packet, a second band-allocation-response packet is transferred from the data reception terminal 1000 to the first relay device 2000, from the first relay device 2000 to the second relay device 3000, and from the second relay device 3000 to the data transmission terminal 4000 (Steps S1119, S1120 and S1121).

Upon receiving the second band-allocation-response packet, the data transmission terminal 4000 acknowledges that the bandwidth s1 has been reserved by the first relay device 2000 and the second relay device 3000 (Step S1122).

As set forth, in the above case, the bandwidth allocated by the first relay device 2000 and the bandwidth allocated by the second relay device 3000 are different from each other.

The second problem is discussed below with reference to FIG. 15. FIG. 15 shows a sequence diagram illustrating a case where the data reception terminal requests cancellation of a bandwidth reservation while the data transmission terminal makes a bandwidth reservation.

The data reception terminal 1000 generates a band-cancellation-request packet (Step S1201) and outputs the generated band-cancellation-request packet to the first relay device 2000 (Step S1202). The first relay device 2000 cancels the reservation of bandwidth b5 as requested by the band-cancellation-request packet (Step S1203) and transfers the band-cancellation-request packet to the second relay device 3000 (Step S1204).

In the meantime, the data transmission terminal 4000 generates a band-allocation-request packet that includes information such as bandwidth b5 to be requested (Step S1205), and transfers the generated band-allocation-request packet to the second relay device 3000 (Step S1206). The second relay device 3000 reserves the bandwidth b5 as requested by the band-allocation-request packet (Step S1207) and transfers the band-allocation-request packet to the first relay device 2000 (Step S1208).

After reserving the bandwidth b5 as requested by the band-allocation-request packet, the second relay device 3000 cancels the reservation of the bandwidth b5 as requested by the band-cancellation-request packet received from the first relay device 2000 (Step S1209). The second relay device 3000 then transfers the band-cancellation-request packet to the data transmission terminal 4000 (Step S1210).

Upon receiving the band-cancellation-request packet, the data transmission terminal 4000 acknowledges that the reservation of the bandwidth b5 has been cancelled by the first relay device 2000 and the second relay device 3000 (Step S1211).

After canceling the reservation of the bandwidth b5 as requested by the band-cancellation-request packet, the first relay device 2000 reserves the bandwidth b5 as requested by the band-allocation-request packet received from the second relay device 3000 (Step S1212). The first relay device 2000 then transfers the band-allocation-request packet to the data reception terminal 1000 (Step S1213).

Upon receiving the band-allocation-request packet, the data reception terminal 1000 acknowledges that the bandwidth b5 has been reserved by the first relay device 2000 and the second relay device 3000 (Step S1214).

In response to the band-cancellation-request packet, a band-cancellation-response packet is transferred from the data transmission terminal 4000 to the second relay device 3000, from the second relay device 3000 to the first relay device 2000, and from the first relay device 2000 to the data reception terminal 1000 (Steps S1215, S1216 and S1217).

Upon receiving the band-cancellation-response packet, the data reception terminal 1000 acknowledges that the reservation of the bandwidth b5 has been cancelled by the first relay device 2000 and the second relay device 3000 (Step S1218).

In response to the band-allocation-request packet, a band-allocation-response packet is transferred from the data reception terminal 1000 to the first relay device 2000, from the first relay device 2000 to the second relay device 3000, and from the second relay device 3000 to the data transmission terminal 4000 (Steps S1219, S1220 and S1221).

Upon receiving the band-allocation-response packet, the data transmission terminal 4000 acknowledges that the bandwidth b5 has been reserved by the first relay device 2000 and the second relay device 3000 (Step S1222).

As set forth, the first relay device 2000 has reserved the bandwidth b5 while the second relay device has cancelled the reservation of the bandwidth b5.

In view of the above problems, the present invention aims to provide a communication system and a communication method that can prevent relay devices, which exist on a path interconnecting a data transmission terminal and a data reception terminal, from setting different network resources from each other, even in a case where both the data transmission terminal and the data reception terminal can request processing for securing the network resource.

### Means to Solve the Problems

In order to solve the above problems, a communication system of the present invention includes a data transmission terminal, a data reception terminal and at least one relay device that relays data communication performed between the data transmission terminal and the data reception terminal, wherein (i) each of the data transmission terminal and the data reception terminal transmits a request signal via a communications channel to the relay device, the request signal requesting a network resource processing that is processing associated with a network resource of a path used for the data communication, and (ii) the relay device includes: a judgment unit operable to judge whether or not the request signal, which has been newly received from the data transmission terminal or the data reception terminal, satisfies a condition that the newly received request signal should satisfy with respect to a prior request signal, the condition being for restraining execution of the network resource processing requested by the newly received request signal; a restraint unit operable to, when the judgment unit judges that the newly received request signal satisfies the condition, restrain the execution of the network resource processing; and an execution unit operable to, when the judgment unit judges that the newly received request signal does not satisfy the condition, execute the network resource processing.

A communication method of the present invention is incorporated in a communication system including a data transmission terminal, a data reception terminal and at least one relay device that relays data communication performed between the data transmission terminal and the data reception terminal, wherein the relay device includes: a reception unit operable to newly receive a request signal from the data transmission terminal or the data reception terminal, the request signal requesting network resource processing that is processing associated with a network resource of a path used for the data communication; a judgment unit operable to judge whether or not the request signal newly received by the reception unit satisfies a condition that the newly received request signal should satisfy with respect to a prior request signal, the condition being for restraining execution of the network resource processing requested by the newly received request signal; a restraint unit operable to, when the judgment unit judges that the newly received request signal satisfies the condition, restrain the execution of the network processing; and an execution unit operable to, when the judgment unit judges that the newly received request signal does not satisfy the condition, execute the network processing.

Note, examples of network resource processing include processing for reserving a requested bandwidth and processing for canceling a secured reservation of bandwidth.

### EFFECTS OF THE INVENTION

According to the above communication system and communication method, the relay device (i) judges whether or not the newly received request signal satisfies the condition, (ii) when judging that the newly received request signal satisfies the condition, does not execute the network resource processing requested by the newly received request signal, and (iii) when judging that the newly received request signal does not satisfy the condition, executes the network resource processing requested by the newly received request signal. Therefore, even if the data transmission terminal and the data reception terminal request two different network resource processing, the relay device can prevent execution of such two different network resource processing that have been requested by the request signals transmitted by the data transmission terminal and the data reception terminal. Consequently, the above communication system and communication method can prevent the relay device, which exists on the path interconnecting the data transmission terminal and the data reception terminal, from setting different network resources from each other.

In the above communication system, the condition may define a relationship between (i) a flow direction in which the newly received request signal is transmitted and (ii) a flow direction in which the prior request signal is transmitted, each flow direction specifying one of an upstream direction and a downstream direction.

With this structure, all the relay device has to do is check the relationship between a data flow of the newly received request signal and a data flow of the prior request signal. It is thus possible to easily and reliably prevent relay devices, which exist on the path interconnecting the data transmission terminal and the data reception terminal, from setting different network resources from each other.

In the above communication system, each of the data transmission terminal and the data reception terminal may add, to the request signal of own terminal, flow information indicating the flow direction of the request signal of own terminal, and based on the flow information added to the newly received request signal, the judgment unit of the relay device may judge whether or not the newly received request signal satisfies the condition.

With this structure, each of the data transmission terminal and the data reception terminal adds, to the request signal of own terminal, the flow information indicating the flow direction of the request signal of own terminal. Accordingly, the relay device can easily and reliably identify the flow direction of the request signal.

In the above communication system, each of the request signal and the prior request signal may indicate a bandwidth to request, and the condition may define a relationship between (i) a size of the bandwidth indicated by the newly received request signal and (ii) a size of the bandwidth indicated by the prior request signal.

With this structure, all the relay device has to do is check the relationship between (i) the size of the bandwidth indicated by the newly received request signal and (ii) the size of the bandwidth indicated by the prior request signal. It is thus possible to easily and reliably prevent relay devices, which exists on the path interconnecting the data transmission terminal and the data reception terminal, from setting different network resources from each other.

In the above communication system, the condition may define that a band-cancellation-request signal, which is a request signal requesting cancellation of a bandwidth reservation, is given priority over a band-allocation-request-signal, which is a request signal requesting allocation of the bandwidth.

With this structure, in a case where one of the data transmission terminal and the data reception terminal makes a band cancellation request while the other makes a band allocation request, the band cancellation request is given priority. This makes all relay devices existing on the path interconnecting the data transmission terminal and the data reception terminal cancel a bandwidth reservation that has been requested to be cancelled. Accordingly, it is possible to prevent a situation where, out of all the relay devices existing on the stated path, some cancels the bandwidth reservation while the rest keeps the bandwidth reserved.

### BRIEF DESCRIPTION OF THE DRAWINGS

FIG. 1 shows a system structure of a communication system pertaining to one embodiment of the present invention;

FIG. 2 shows the device structure of a data transmission terminal and a data reception terminal pertaining to the present invention;

FIG. 3 shows information sets stored in a flow information storage unit that is illustrated in FIG. 2;

FIG. 4 shows the device structure of a relay device pertaining to the present invention;

FIG. 5 shows information sets stored in an allocated band storage unit that is illustrated in FIG. 4;

FIG. 6 shows information sets stored in a path information storage subunit that is included in a path setting unit illustrated in FIG. 4;

FIG. 7 is a flowchart showing a processing flow of a transmission/reception terminal (the data transmission terminal and the data reception terminal) illustrated in FIG. 2;

FIG. 8 is a flowchart showing a processing flow of the relay device illustrated in FIG. 4;

FIG. 9 shows an operation sequence illustrating flow information acquisition processing and path setting processing performed in the communication system pertaining to the embodiment of the present invention;

FIG. 10 shows an operation sequence illustrating a flow of band reservation processing performed in the communication system pertaining to the embodiment of the present invention;

FIG. 11 shows an operation sequence illustrating flows of band reservation processing performed in the communication system pertaining to the embodiment of the present invention;

FIG. 12 shows an operation sequence illustrating flows of band reservation processing and band cancellation processing performed in the communication system pertaining to the embodiment of the present invention;

FIG. 13 shows an operation sequence illustrating a flow of band reservation processing performed in a conventional communication system;

FIG. 14 shows an operation sequence for illustrating a problem of the conventional communication system;

FIG. 15 shows an operation sequence for illustrating another problem of the conventional communication system.

### DESCRIPTION OF CHARACTERS

10 transmission/reception terminal
11 request generation unit
12 flow information storage unit
13 port number setting unit
14 IP address setting unit
15 flow information setting unit
16 packet generation unit
17 data processing unit
18 protocol processing unit
19 communication unit
50 relay device
51 wired communication unit
52 wireless communication unit
53 request packet detection unit
54 allocated band storage unit
55 processed request distinguishing unit
56 request type distinguishing unit
57 port number retrieving unit
58 IP address retrieving unit
59 flow information retrieving unit
60 band allocation/cancellation control unit
61 processing result adding unit

### BEST MODE FOR CARRYING OUT THE INVENTION

One embodiment of the present invention will be described below with reference to the drawings.

### <<Structure of Communication System>>

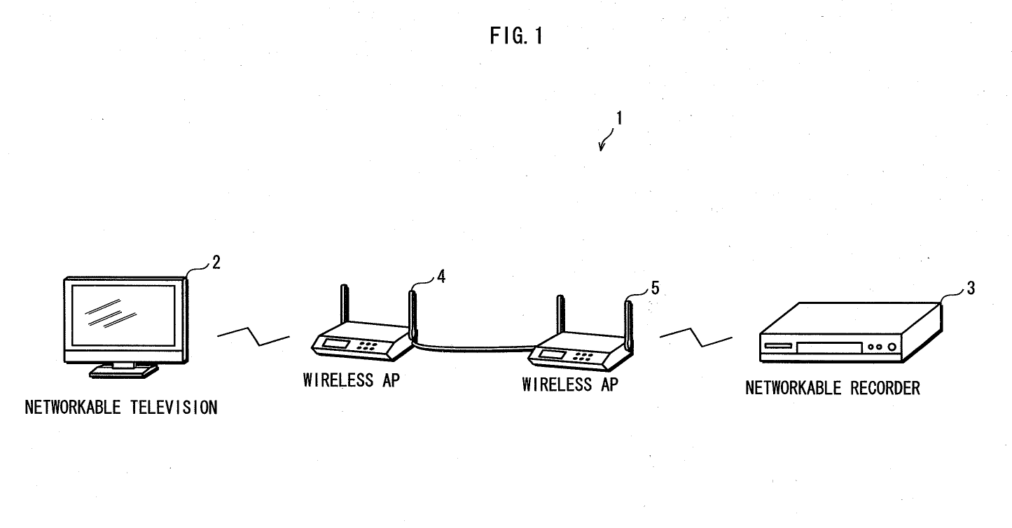

The following describes the structure of a communication system pertaining to one embodiment of the present invention, with reference to FIG. 1. FIG. 1 shows a system structure of a communication system pertaining to the present embodiment.

In a communication system 1, whose structure is exemplarily shown in FIG. 1, a networkable television 2 and a networkable recorder 3 are interconnected via wireless access points 4 and 5.

The networkable television 2 and the wireless access point 4 are wirelessly connected to each other. The networkable recorder 3 and the wireless access point 5 are wirelessly connected to each other. The access points 4 and 5 are connected to each other by a wired connection.

Note, the networkable television 2 functions both as a data transmission terminal and as a data reception terminal. Likewise, the networkable recorder 3 functions both as a data transmission terminal and as a data reception terminal.

The wireless access points 4 and 5 each function as a relay device. Another relay device, such as a router and a bridge, may be provided between the wireless access points 4 and 5.

The communication system 1 configures end-to-end QoS settings. Note, it is regarded in the present embodiment that a bandwidth reservation is made in a wireless interval but not in a wired interval, because bandwidth is large in the wired interval. In the case of FIG. 1, a bandwidth reservation is made between the networkable television 2 and the wireless access point 4, as well as between the networkable recorder 3 and the wireless access point 5; contrarily, a bandwidth reservation is not made between the wired access points 4 and 5.

In making a bandwidth reservation, the following condition needs to be satisfied: in each connection unit (discussed later), a band allocation request (for reserving bandwidth) transmitted from the data reception terminal to the data transmission terminal is given priority over a band allocation request transmitted from the data transmission terminal to the data reception terminal. Under this condition, processing for reserving bandwidth is performed in a path through which the data communication is performed between the data transmission terminal and the data reception terminal.

In a case where both a bandwidth reservation and cancellation of a bandwidth reservation are made on the same connection, the following condition needs to be satisfied: a band cancellation request for canceling a bandwidth reservation is given priority over a band allocation request for reserving bandwidth. Under this condition, processing for reserving bandwidth or processing for canceling a bandwidth reservation is performed in the path through which the data communication is performed between the data transmission terminal and the data reception terminal. Giving priority to the cancellation of the bandwidth reservation over the bandwidth reservation as described above makes it possible to, for example, prevent a bandwidth reservation from being made on a connection associated with a deactivated terminal.

In the present embodiment, bandwidth is allocated in each so-called TCP connection unit or so-called UDP connection unit. Here, each of the TCP connection and the UDP connection is a path between a transmission terminal and a reception terminal, and is identified by a pair of (i) an IP address and a port number of the transmission terminal and (ii) an IP address and a port number of the reception terminal.

Each connection (TCP connection, UDP connection) is established between one data transmission terminal and one data reception terminal. It is thus possible to identify a connection, as long as a pair of an IP address and a port number of one of the data transmission terminal and the data reception terminal is identified.

### <<Structure of Data Transmission Terminal and Data Reception Terminal>>

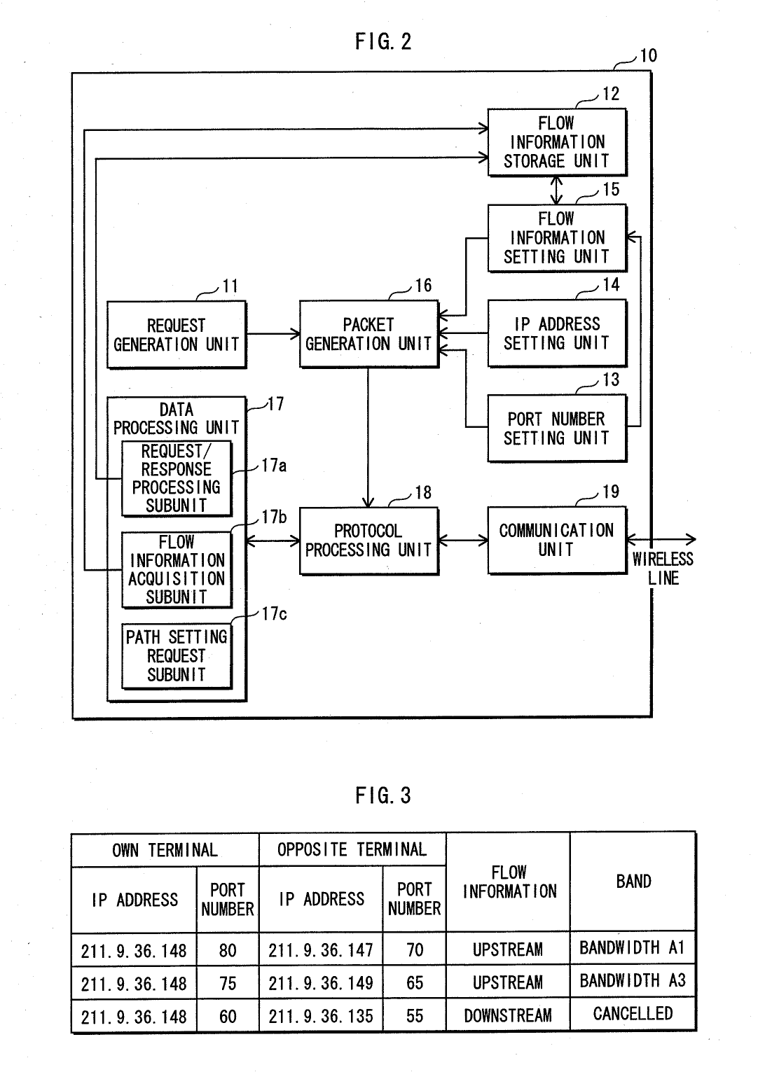

The following describes the structure of the data transmission terminal and the data reception terminal pertaining to the present embodiment, with reference to FIG. 2. FIG. 2 shows the device structure of the data transmission terminal and the data reception terminal. Note, because the data transmission terminal and the data reception terminal share the same features related to the present invention, they will be referred to hereinafter as a transmission/reception terminal. It is to be understood that the networkable television 2 and the networkable recorder 3 in FIG. 1 are each equivalent to the transmission/reception terminal.

A transmission/reception terminal 10 includes a request generation unit 11, a flow information storage unit 12, a port number setting unit 13, an IP address setting unit 14, a flow information setting unit 15, a packet generation unit 16, a data processing unit 17, a protocol processing unit 18, and a communication unit 19.

The request generation unit 11 generates a band allocation request and a band cancellation request, and outputs the generated band allocation request and band cancellation request to the packet generation unit 16. Note, the band allocation request is for requesting an allocation of bandwidth and includes information of this bandwidth to be allocated as requested. Also note, the band cancellation request is for requesting cancellation of a bandwidth reservation.

The flow information storage unit 12 stores therein, for each connection unit (UDP connection, TCP connection), (i) flow information and (ii) bandwidth or cancellation of a bandwidth reservation. One example of the flow information storage unit 12 will be described below with reference to FIG. 3. FIG. 3 shows information sets stored in the flow information storage unit 12.

The flow information storage unit 12 stores therein a pair of (i) an IP address and a port number of its own terminal and (ii) an IP address and a port number of another terminal with which its own terminal is to communicate (hereafter, “opposite terminal”); this pair is to identify a connection (UDP connection, TCP connection).

The flow information storage unit 12 also stores therein, in correspondence with information for identifying the connection, a pair of (i) flow information and (ii) bandwidth or cancellation of a bandwidth reservation.

When the flow information indicates UPSTREAM, it means that its own terminal is to receive data. On the other hand, when the flow information indicates DOWNSTREAM, it means that its own terminal is to transmit data.

Either an allocated bandwidth or cancellation of a bandwidth reservation is stored into the BAND column. When the BAND column indicates CANCELLED, it means that the bandwidth reservation has been cancelled.

The flow information storage unit 12 may be configured such that it does not store the IP address of its own terminal.

The port number setting unit 13 outputs, to the packet generation unit 16 and the flow information setting unit 15, a port number of application software that makes the band allocation request and the band cancellation request.

The IP address setting unit 14 outputs the IP address of its own terminal, which has been prestored therein, to the packet generation unit 16.

The flow information setting unit 15 (i) searches, from among the information sets stored in the flow information storage unit 12, an information set including the port number of its own terminal that matches the port number input by the port number setting unit 13, and (ii) retrieves flow information from the searched information set. The flow information setting unit 15 outputs the retrieved flow information to the packet generation unit 16.

The packet generation unit 16 can generate a band-allocation-request packet by adding the following to the band allocation request input by the request generation unit 11: (i) the port number input by the port number setting unit 13; (ii) the IP address input by the IP address setting unit 14; and (iii) the flow information input by the flow information setting unit 15. The packet generation unit 16 then outputs the generated band-allocation-request packet to the protocol processing unit 18.

The packet generation unit 16 can also generate a band-cancellation-request packet by adding the following to the band cancellation request input by the request generation unit 11: (i) the port number input by the port number setting unit 13; (ii) an IP address input by the IP address setting unit 14; and (iii) the flow information input by the flow information setting unit 15. The packet generation unit 15 then outputs the generated band-cancellation-request packet to the protocol processing unit 18.

The data processing unit 17 processes the transmitted/received data, and includes a request/response processing subunit 17a, a flow information acquisition subunit 17b, and a path setting request subunit 17c.

The request/response processing subunit 17a performs processing for handling the band allocation request and the band allocation response.

The flow information acquisition subunit 17b acquires flow information corresponding to the pair of (i) the IP address and the port number of its own terminal and (ii) the IP address and the port number of the opposite terminal. The flow information acquisition subunit 17b stores, into the flow information storage unit 12, the flow information acquired in correspondence with the pair of (i) the IP address and the port number of its own terminal and (ii) the IP address and the port number of the opposite terminal.

The path setting request subunit 17c generates a path-setting-request packet for setting a path through which data or the like is transmitted between its own terminal and the opposite terminal. The path setting request subunit 17c outputs the generated path-setting-request packet to the protocol processing unit 18. Upon receiving this path setting request, a relay device configures settings for another relay device and another terminal to which the data or the like is to be transferred.

The protocol processing unit 18 performs predetermined protocol processing. Note, since the protocol processing performed by the protocol processing unit 18 is not directly related to the present invention, an explanation of the protocol processing is omitted.

The communication unit 19, for example, wirelessly connects its own terminal to the relay device.

### <<Structure of Relay Device>>

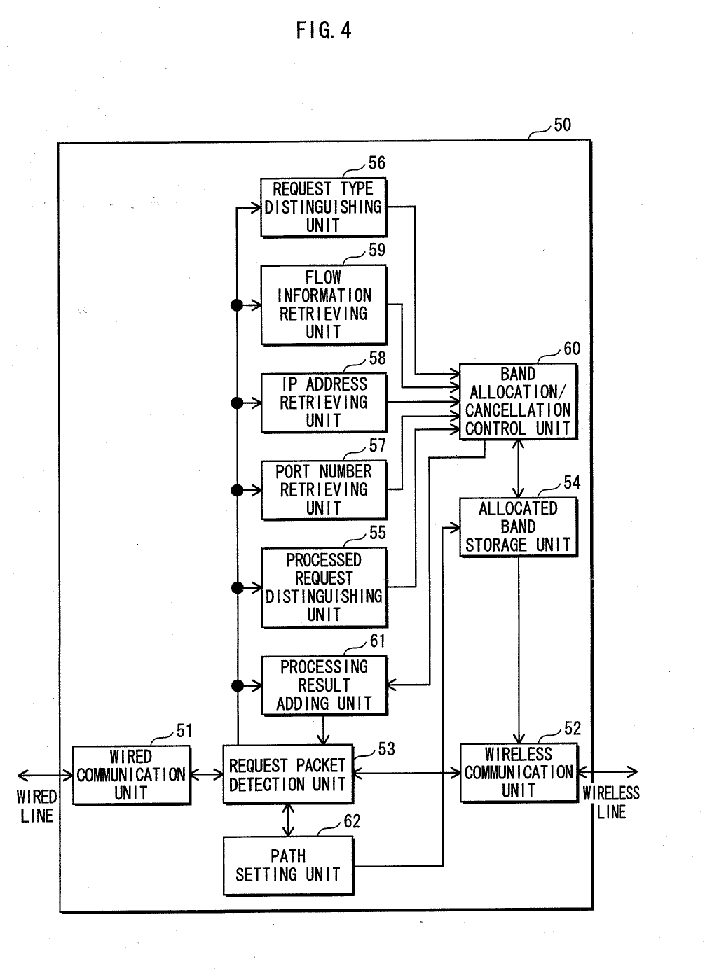

Described below with reference to FIG. 4 is the device structure of a relay device pertaining to the present embodiment. FIG. 4 shows the device structure of the relay device. Note, the wireless access points 4 and 5 shown in FIG. 1 are equivalent to the relay device.

A relay device 50 includes a wired communication unit 51, a wireless communication unit 52, a request packet detection unit 53, an allocated band storage unit 54, a processed request distinguishing unit 55, a request type distinguishing unit 56, a port number retrieving unit 57, an IP address retrieving unit 58, a flow information retrieving unit 59, a band allocation/cancellation control unit 60, a processing result adding unit 61, and a path setting unit 62.

The wired communication unit 51, for example, connects its own device to another relay device by a wired connection. The wireless communication unit 52 wirelessly connects its own device to the transmission/reception terminal.

The request packet detection unit 53 detects the band-allocation-request packet and the band-cancellation-request packet from among packets input by the wired communication unit 51 and the wireless communication unit 52. The request packet detection unit 53 outputs the detected band-allocation-request packet and band-cancellation-request packet to the processed request distinguishing unit 55, the request type distinguishing unit 56, the port number retrieving unit 57, the IP address retrieving unit 58, the flow information retrieving unit 59, and the processing result adding unit 61.

The request packet detection unit 53 detects the path-setting-request packet from among packets input by the wired communication unit 51 and the wireless communication unit 52, and outputs the detected path-setting-request packet to the path setting unit 62.

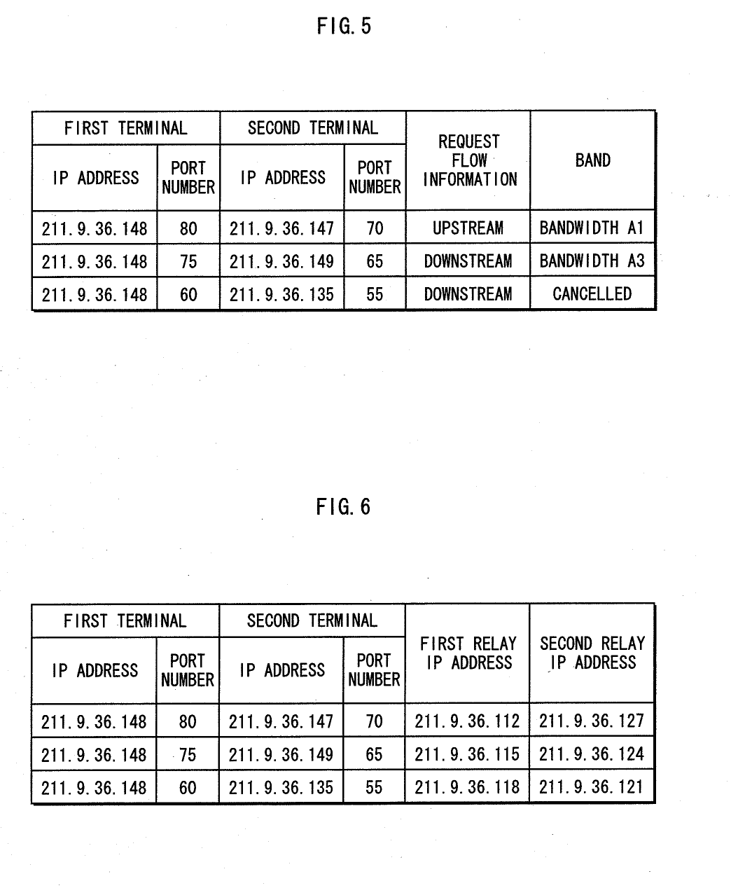

The allocated band storage unit 54 stores therein, for each connection unit (UDP connection, TCP connection), a pair of (i) a request flow information and (ii) bandwidth or cancellation of a bandwidth reservation. One example of the allocated band storage unit 54 will be described below with reference to FIG. 5. FIG. 5 shows information sets stored in the allocated band storage unit 54.

The allocated band storage unit 54 stores therein a pair of (i) an IP address and a port number of a first terminal and (ii) an IP address and a port number of a second terminal; this pair is to identify a connection (UDP connection, TCP connection).

The allocated band storage unit 54 also stores therein, in correspondence with information for identifying the connection, a pair of (i) a request flow information and (ii) bandwidth or cancellation of a bandwidth reservation.

Stored into the REQUEST FLOW INFORMATION column is either (i) the flow information added to the band allocation request which has requested the bandwidth to be reserved in the connection, or (ii) the flow information added to the band cancellation request which has requested cancellation of the bandwidth reserved in the connection.

When the request flow information indicates UPSTREAM, it means that the bandwidth has been allocated or that the bandwidth reservation has been cancelled, by processing according to the band allocation request or the band cancellation request transmitted by the data reception terminal. On the other hand, when the request flow information indicates DOWNSTREAM, it means that the bandwidth has been allocated or that the bandwidth reservation has been cancelled, by processing according to the band allocation request or the band cancellation request transmitted by the data transmission terminal.

The BAND column includes bandwidth allocated to the wireless communication unit 52. The wireless communication unit 52 performs data communication using the bandwidth included in the BAND column of the band allocation storage unit 54. Here, when the BAND column indicates CANCELLED, it means that the bandwidth reservation has been cancelled.

The processed request distinguishing unit 55 distinguishes whether post-processing information has been added to the request packet (the band-allocation-request packet, the band-cancellation-request packet) input by the request packet detection unit 53, and outputs a result of the distinction to the band allocation/cancellation control unit 60. The post-processing information is information indicating that the request packet has failed to make a bandwidth reservation or the like in another relay device located ahead of the relay device 50. If the post-processing information is added to the request packet, then processing for making a bandwidth reservation or the like, which is based on the request packet, is performed by none of the relay devices, the data transmission terminal and the data reception terminal.

The request type distinguishing unit 56 distinguishes whether the request packet input by the request packet detection unit 53 is the band-allocation-request packet or the band-cancellation-request packet, and outputs a result of the distinction to the band allocation/cancellation control unit 60.

The port number retrieving unit 57 retrieves the port number that has been added to the request packet (the band-allocation-request packet or the band-cancellation-request packet) input by the request packet detection unit 53, and outputs the retrieved port number to the band allocation/cancellation control unit 60.

The IP address retrieving unit 58 retrieves the IP address that has been added to the request packet (the band-allocation-request packet or the band-cancellation-request packet) input by the request packet detection unit 53, and outputs the retrieved IP address to the band allocation/cancellation control unit 60.

The flow information retrieving unit 59 retrieves the flow information that has been added to the request packet (the band-allocation-request packet or the band-cancellation-request packet) input by the request packet detection unit 53, and outputs the retrieved flow information to the band allocation/cancellation control unit 60.

The band allocation/cancellation control unit 60 has been preconfigured to satisfy the following conditions: “in making a bandwidth reservation, the flow information indicating UPSTREAM is given priority over the flow information indicating DOWNSTREAM”; and “cancellation of a bandwidth reservation is given priority over a bandwidth reservation.”

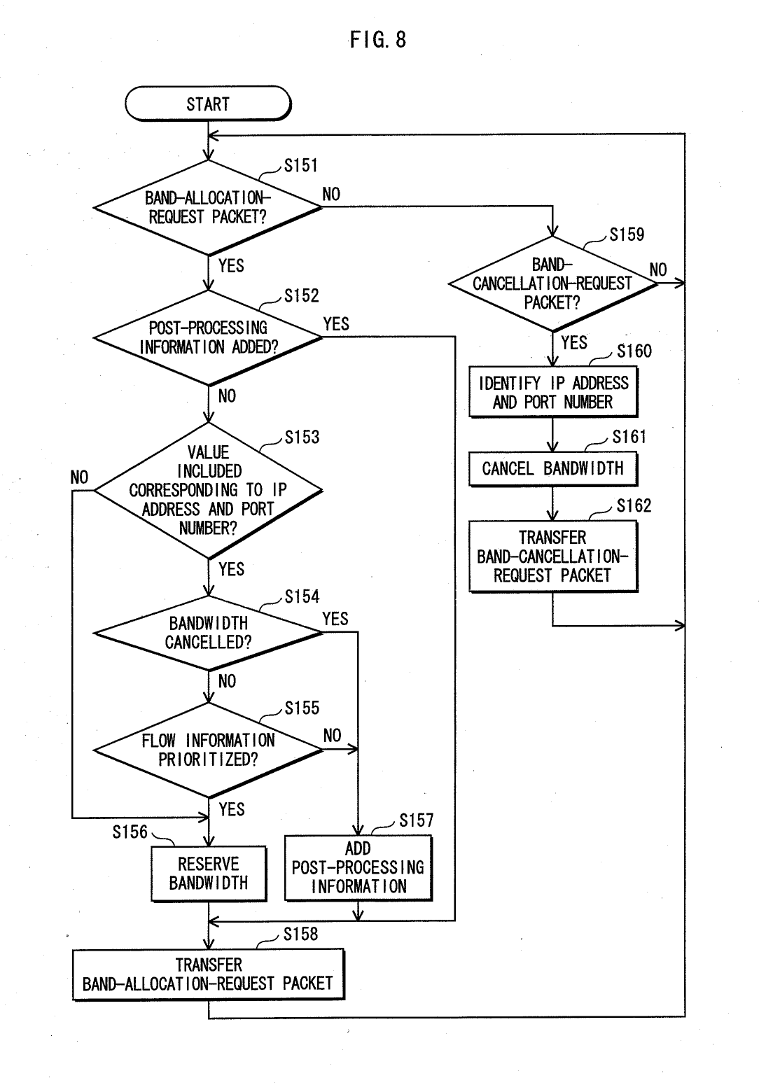

The band allocation/cancellation control unit 60 makes a bandwidth reservation or cancels a bandwidth reservation according to information input by the processed request distinguishing unit 55, the request type distinguishing unit 56, the port number retrieving unit 57, the IP address retrieving unit 58, and the flow information retrieving unit 59. The band allocation/cancellation control unit 60 then updates the corresponding information set stored in the allocated band storage unit 54. The details of processing performed by the band allocation/cancellation control unit 60 will be discussed later with reference to FIG. 8.

Based on the information input by the band allocation/cancellation control unit 60, the processing result adding unit 61 adds post-processing information to the request packet (the band-allocation-request packet, the band-cancellation-request packet) input by the packet detection unit 53, and returns the request packet to the packet detection unit 53. The packet detection unit 53 outputs the returned request packet (i) to the wireless communication unit 52 if the request packet has been input by the wired communication unit 51 and (ii) to the wired communication unit 51 if the request packet has been input by the wireless communication unit 52.

The path setting unit 62 stores therein a path information storage subunit. One example of the path information storage subunit will be described below with reference to FIG. 6. FIG. 6 shows information sets stored in the path information storage subunit.

The path information storage subunit stores therein a pair of (i) an IP address and a port number of the first terminal and (ii) and an IP address and a port number of the second terminal; this pair is to identify a connection (TCP connection, UDP connection).

The path information storage subunit also stores therein, for each connection unit, a first relay IP address and a second relay IP address. Here, the first relay IP address is an IP address of another relay device or a terminal (the data transmission terminal or the data reception terminal) that is located ahead of its own device, whereas the second relay IP address is an IP address of another relay device or a terminal (the data transmission terminal or the data reception terminal) that is located behind its own device.

The path setting unit 62 stores, into the FIRST RELAY IP ADDRESS column of the path information storage subunit, an IP address of another relay device or a terminal that has transmitted the path-setting-request packet. Furthermore, the path setting unit 62 refers to the destination of the path-setting-request packet and then determines, with use of a routing table (not illustrated), a relay device or a terminal to which its own device should transfer the path-setting-request packet. The path setting unit 62 stores, into the SECOND RELAY IF ADDRESS column of the path information storage subunit, an IP address of the determined relay device or terminal.

### <<Operations of Data Transmission Terminal and Data Reception Terminal>>

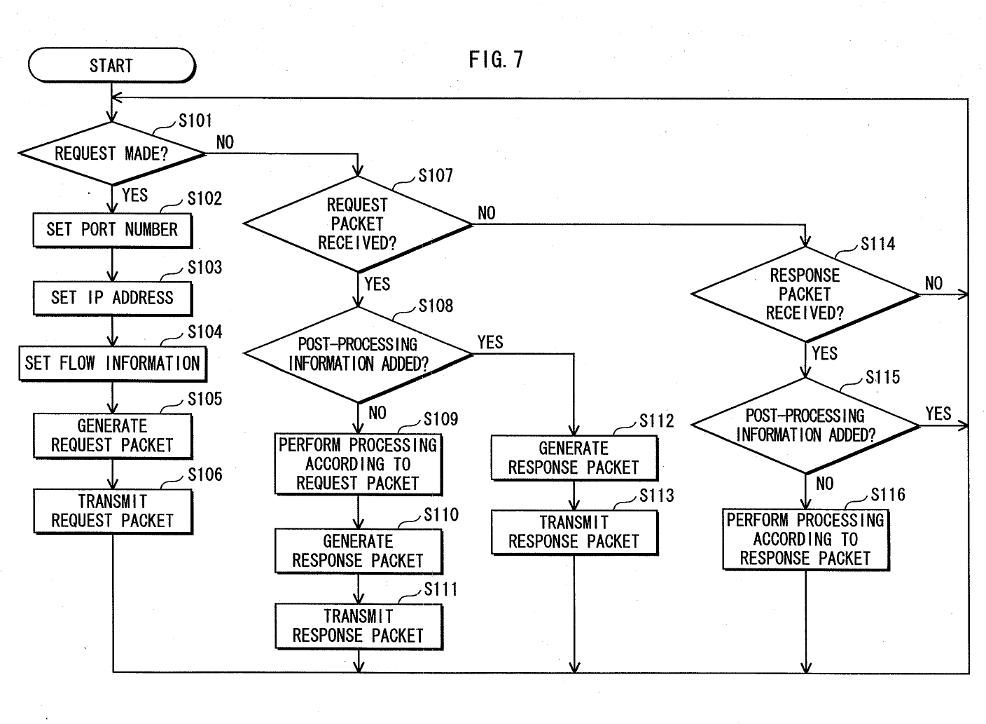

The following describes processing performed by the data transmission terminal and the data reception terminal whose device structure has been explained using FIG. 2. FIG. 7 is a flowchart showing a processing flow of the data transmission terminal and the data reception terminal. It should be noted that FIG. 7 shows the processing performed by the data transmission terminal and the data reception terminal in association with the band allocation request and the band cancellation request. Both the data transmission terminal and the data reception terminal practically perform this processing just the same.

The packet generation unit 16 judges whether or not a request (the band allocation request, the band cancellation request) has been input thereto by the request generation unit 11 (Step S101). If the request has been input (the YES branch of S101), then processing of Step S102 is performed. If the request has not been input (the NO branch of S101), then processing of Step S107 is performed.

The port number setting unit 13 outputs, to the packet generation unit 16, a port number of application software that has made the request (Step S102). The IP address setting unit 14 outputs the IP address of its own terminal to the packet generation unit 16 (Step S103). The flow information setting unit 15 (i) searches, from among the information sets stored in the flow information storage unit 12, an information set including the port number of its own terminal that matches the port number input by the port number setting unit 13, and (ii) retrieves flow information from the searched information set. The flow information setting unit 15 then outputs the retrieved flow information to the packet generation unit 16 (Step S104). The packet generation unit 16 generates a request packet (a band-allocation-request packet, a band-cancellation-request packet) by adding the port number, the IP address and the flow information to the request input by the request generation unit 11, and outputs the generated request packet to the protocol processing unit 18 (Step S105). The protocol processing unit 18 performs predetermined processing on the request packet. The request packet is then output by the communication unit 19 (Step S106). Subsequently, the processing of Step S101 is performed.

The request/response processing subunit 17a of the data processing unit 17 judges, based on the data input thereto via the communication unit 19 and the protocol processing unit 18, whether or not its own terminal has received a request packet (a band-allocation-request packet, a band-cancellation request packet) from the opposite terminal (Step S107). If it has received the request packet (the YES branch of S107), processing of Step S108 is performed. If it has not received the request packet (the NO branch of S107), processing of Step S114 is performed.

The request/response processing subunit 17a further judges whether or not the post-processing information has been added to the request packet (Step S108). If the post-processing information has been added (the YES branch of S108), processing of Step S112 is performed. If the post-processing information has not been added (the No branch of S108), processing of Step S109 is performed.

The request/response processing subunit 17a performs processing as requested by the request packet (Step S109).

Specifically, in the case where the request packet is the band-allocation-request packet, the request/response processing subunit 17a (i) searches, from among the information sets stored in the flow information storage unit 12, an information set that includes the IP address and the port number of the opposite terminal that match the IP address and the port number included in the band-allocation-request packet, and (ii) rewrites the bandwidth of the searched information set as the bandwidth included in the band-allocation-request packet. From then on, the data communication will be performed using the rewritten bandwidth.

In the case where the request packet is the band-cancellation-request packet, the request/response processing subunit 17a (i) searches, from among the information sets stored in the flow information storage unit, an information set that includes the IP address and the port number of the opposite terminal that match the IP address and the port number included in the band-cancellation-request packet, and (ii) rewrites the bandwidth of the searched information set as CANCELLED.

In response to the request packet, the request/response processing subunit 17a generates a response packet (a band-allocation-response packet, a band-cancellation-response packet) that includes the IP address, the port number and the bandwidth included in the request packet, and outputs the generated response packet to the protocol processing unit 18 (Step S110). The protocol processing unit 18 performs predetermined processing on the response packet. The response packet is then output by the communication unit 19 (Step S111). Subsequently, the processing of Step S101 is performed.

In the case where the post-processing information has been added to the request packet, the request/response processing subunit 17a (i) generates, in response to the request packet, a response packet (a band-allocation-response packet, a band-cancellation-response packet) that includes the IP address, the port number and the bandwidth included in the request packet, and (ii) adds the post-processing information to the response packet. The request/response processing subunit 17a outputs the response packet to which the post-processing information has been added to the protocol processing unit 18 (Step S112). The protocol processing unit 18 performs predetermined processing on the response packet to which the post-processing information has been added. The response packet is then output by the communication unit 19 (Step S113). Subsequently; the processing of Step S101 is performed.

The request/response processing subunit 17a judges, based on the data input thereto via the communication unit 10 and protocol processing unit 18, whether or not its own device has received the response packet (the band-allocation-response packet, the band-cancellation-response packet) from the opposite terminal (Step S114). If it has received the response packet (the YES branch of S114), processing of Step S115 is performed. If it has not received the response packet (the NO branch of S114), the processing of Step S101 is performed.

The request/response processing subunit 17a further judges whether or not the post-processing information has been added to the response packet (Step S115). If the post-processing information has been added (the YES branch of S115), the processing of Step S101 is performed. If the post-processing information has not been added (the NO branch of S115), processing of Step S116 is performed.

The request/response processing subunit 17a performs processing as requested by the response packet (Step S116). Then, the processing of Step S101 is performed.

Specifically, in the case where the response packet is the band-allocation-response packet, the request/response processing subunit 17a (i) searches, from among the information sets stored in the flow information storage unit 12, an information set that include the IP address and the port number of its own terminal that match the IP address and the port number of the band-allocation-response packet, and (ii) rewrites the bandwidth of the searched information set as the bandwidth included in the band-allocation-response packet. From then on, the data communication will be performed using the rewritten bandwidth.

In the case where the request packet is the band-cancellation-response packet, the request/response processing subunit 17a (i) searches, from among the information sets stored in the flow information storage unit 12, an information set that includes the IP address and the port number of its own terminal that match the IP address and the port number included in the band-cancellation-response packet, and (ii) rewrites the bandwidth of the searched information set as CANCELLED.

<<operations of Relay Device>>

With reference to FIG. 8, the following describes processing performed by the relay device whose device structure has been explained using FIG. 4. FIG. 8 is a flowchart showing a processing flow of the relay device. It should be noted that FIG. 8 shows the processing performed by the relay device in association with the band-allocation-request packet and the band-cancellation-request packet.

The request packet detection unit 60 detects the request packet (the band-allocation-request packet, the band-cancellation-request packet). The request type distinguishing unit 56 distinguishes different types of request packet (the band-allocation-request packet, the band-cancellation-request packet). Based on a result of the distinction input by the request type distinguishing unit 56, the band allocation/cancellation control unit 60 judges whether or not the detected request packet is the band-allocation-request packet (Step S151).

If it is the band-allocation-request packet (the YES branch of S151), processing of Step S152 is performed.

The processed request distinguishing unit 55 distinguishes whether or not the post-processing information has been added to the request packet. Based on a result of the distinction input by the processed request distinguishing unit 55, the band allocation/cancellation control unit 60 judges whether the post-processing information has been added to the detected request packet (Step S152). If the post-processing information has been added (the YES branch of S152), the relay device transfers the band-allocation-request packet without reserving the bandwidth requested by the band-allocation-request packet (Step S158).

If the post-processing information has not been added (the NO branch of S152), the port number retrieving unit 57 and the IP address retrieving unit 58 retrieve the port number and the IP address included in the detected band-allocation-request packet, respectively. The band allocation/cancellation control unit 60 searches, from among the information sets stored in the allocated band storage unit 54, an information set whose FIRST TERMINAL column or SECOND TERMINAL column includes the retrieved IP address and port number. The band allocation/cancellation control unit 60 judges whether or not the BAND column of the searched information set includes any value (i.e., a certain bandwidth or CANCELLED) (Step S153).

If the BAND column of the searched information set includes no value (the NO branch of S153), then it means that the detected band-allocation-request packet relates to a connection in which a bandwidth reservation has been neither made nor cancelled so far; subsequently, processing of Step S156 is performed.

The band allocation/cancellation control unit 60 writes (i) the flow information included in the detected band-allocation-request packet into the REQUEST FLOW INFORMATION column of the searched information set, and (ii) the bandwidth included in the detected band-allocation-request packet into the BAND column of the searched information set (Step S156). Then, the relay device transfers the band-allocation-request packet (Step S158).

If the band column of the searched information set includes any value (the YES branch of S153), the band allocation/cancellation control unit 60 judges whether or not the BAND column of the searched information set indicates CANCELLED (Step S154).

If it indicates CANCELLED (the YES branch of S154), then, because the band cancellation request is given priority over the band allocation request, the band allocation/cancellation control unit 60 makes the processing result adding unit 61 add the post-processing information to the detected band-allocation-request packet without performing the processing for reserving the bandwidth requested by the band-allocation-request packet (Step S157). The relay device then transfers the band-allocation-request packet to which the post-processing information has been added by the processing result adding unit 61 (Step S158) Note, the reservation of the bandwidth requested by the above-described band allocation request can be restrained under the condition that the band cancellation request was made before the above-described band allocation request.

If the BAND column of the searched information set does not indicate CANCELLED (the NO branch of S154), then processing of Step S155 is performed.

The flow information retrieving unit 59 retrieves the flow information included in the detected band-allocation-request packet. The band allocation/cancellation control unit 60 judges whether or not the retrieved flow information is given priority over the request flow information of the information set searched in Step S153 (Step S155). Here, only when the retrieved flow information indicates DOWNSTREAM and the request flow information indicates UPSTREAM, it is judged that the retrieved flow information is not given priority over the request flow information. That is, the reservation of the bandwidth requested by the above-described band allocation request can be restrained under the condition that another band allocation request that includes flow information indicating UPSTREAM was made before the above-described band allocation request that includes flow information indicating DOWNSTREAM.

If it is judged that the retrieved flow information is not given priority over the request flow information of the searched information set (the NO branch of S155), then the band allocation/cancellation control unit 60 makes the processing result adding unit 61 to add the post-processing information to the detected band-allocation-request packet without performing the processing for reserving the bandwidth requested by the detected band-allocation-request packet (Step S157). The relay device then transfers the band-allocation-request packet to which the post-processing information has been added by the processing result adding unit 61 (Step S158).

If it is judged that the retrieved flow information is given priority over the request flow information of the searched information set (the YES branch of S155), then the band allocation/cancellation control unit 60 writes (i) the flow information included in the detected band-allocation-request packet into the REQUEST FLOW INFORMATION column of the information set searched in Step S153 and (ii) the bandwidth included in the detected band-allocation-request packet into the BAND column of the searched information set (Step S156). Then, the relay device transfers the band-request-allocation packet (Step S158).

If the band allocation/cancellation control unit 60 judges that the detected request packet is not the band-allocation-request packet (the NO branch of S151), then the band allocation/cancellation control unit 60 judges, based on a result of the distinction input by the request type distinguishing unit 56, whether or not the detected request packet is the band-cancellation-request packet (Step S159). If the detected request packet is not the band-cancellation-request packet (the NO branch of S159), the processing of Step S151 is performed. On the other hand, if the detected request packet is the band-cancellation-request packet (the YES branch of S159), processing of Step S160 is performed.

The port number retrieving unit 57 and the IP address retrieving unit 58 retrieve the port number and the IP address included in the detected band-cancellation-request packet, respectively. The band allocation/cancellation control unit 60 searches, from among the information sets stored in the allocated band storage unit 54, an information set whose FIRST TERMINAL column or SECOND TERMINAL column includes the retrieved IP address and port number.

The band allocation/cancellation control unit 60 writes (i) the flow information included in the detected band-cancellation-request packet into the REQUEST FLOW INFORMATION column of the information set searched in Step S160, and (ii) “CANCELLED” into the BAND column of the searched information set (Step S161). Then, the relay device transfers the band-cancellation-request packet (Step S162).

### <<Flow Information Acquisition Processing and Path Setting Processing>>

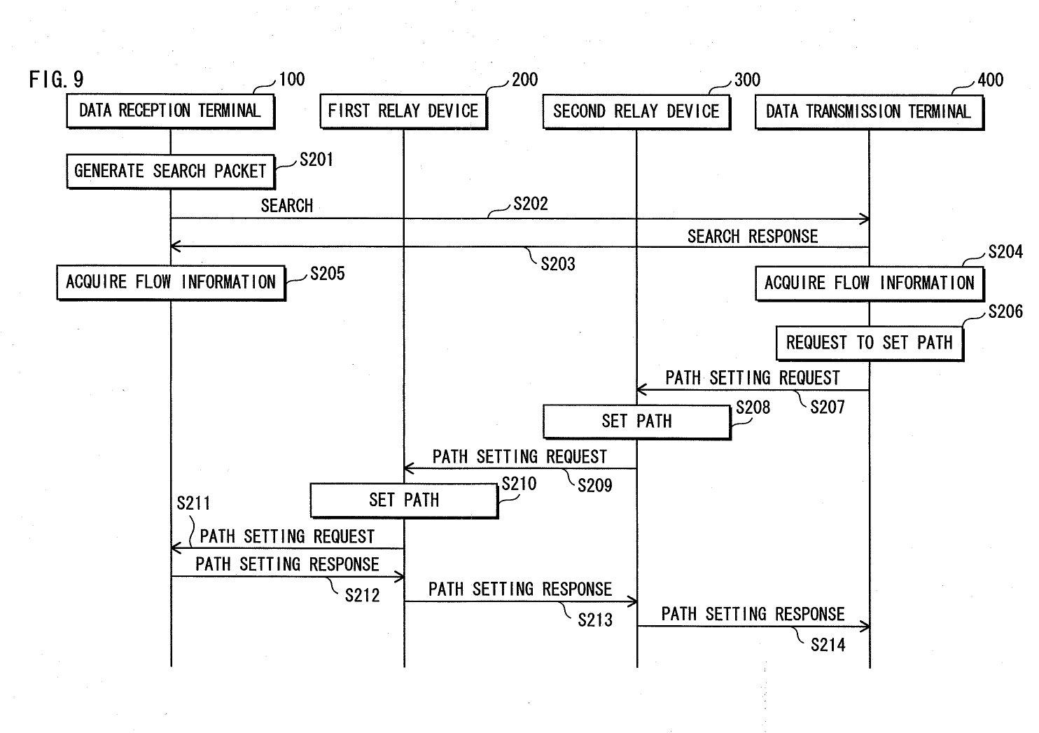

With reference to FIG. 9, the following describes flow information acquisition processing performed by the data transmission terminal and the data reception terminal, and path setting processing performed by the first and second relay devices. FIG. 9 shows an operation sequence illustrating the flow information acquisition processing performed by the data transmission terminal and data reception terminal and the path setting processing performed by the first and second relay devices. Here, a data reception terminal 100 and a data transmission terminal 400 are equivalent to the networkable television 2 and the networkable recorder 3 of FIG. 1, respectively. Also, the first relay device 200 and the second relay device 300 are equivalent to the wireless access points 4 and 5 of FIG. 1, respectively.

In the data reception terminal 100, the flow information acquisition subunit 17b generates a search packet including (i) an IP address of its own terminal and (ii) a port number of application software that requests a search for the data transmission terminal, then outputs the generated search packet to the protocol processing unit 18 (Step S201). The protocol processing unit 18 performs predetermined processing on the search packet. The communication unit 19 then transmits the search packet using multicasting or broadcasting (Step S202).

In the data transmission terminal 400 that has received the search packet, the flow information acquisition subunit 17b generates, in response to the search packet, a search response packet including (i) an IP address of its own terminal and (ii) the port number of the application software corresponding to the request made by the search packet, then outputs the generated search response packet to the protocol processing unit 18. The protocol processing unit 18 performs predetermined processing on the search response packet. Then, using unicast, the communication unit 19 returns the search response packet to the data reception terminal 100 that originally requested the search (Step S203).

In the data transmission terminal 400, the flow information acquisition subunit 17b writes, into the flow information storage unit 12, (i) the IP address and port number included in the search response packet as the IP address and port number of its own terminal, and (ii) the IP address and port number included in the search packet as the IP address and port number of the opposite terminal. Since the data transmission terminal 400 is to transmit data, the flow information acquisition subunit 17b thereof writes “DOWNSTREAM” into the FLOW INFORMATION column of the flow information storage unit 12 (Step S204).

Once the data reception terminal 100 receives the search response packet, the flow information acquisition subunit 17b of the data reception terminal 100 writes, into its flow information storage unit 12, (i) the IP address and port number included in the search packet as the IP address and port number of its own terminal, and (ii) the IP address and port number included in the search response packet as the IP address and port number of the opposite terminal. Since the data reception terminal 100 is to receive data, the flow information acquisition subunit 17b thereof writes “UPSTREAM” into the FLOW INFORMATION column of the flow information storage unit 12 (Step S205).

In the data transmission terminal 400, the path setting request subunit 17c generates a path-setting-request packet that includes (i) the IP address and port number of its own terminal and (ii) the IP address and port number of the opposite terminal, which have been newly written into the flow information storage unit 12, then outputs the generated path-setting-request packet to the protocol processing unit 18 (Step S206). The protocol processing unit 18 performs predetermined processing on the path-setting-request packet. Then, the path-setting-request packet is output via the communication unit 19 to a wireless communications channel (Step S207).

The second relay device 300 receives the path-setting-request packet. In the second relay device 300, the request packet detection unit 53 detects the path-setting-request packet. The path setting unit 62 writes, into the path information storage subunit (FIG. 6) of its own device, the following as the IP address and port number of the first terminal: the IP address and port number that are (i) included in the path-setting-request packet and (ii) of the terminal that has transmitted the path-setting-request packet. The path setting unit 62 also writes, into the path information storage subunit (FIG. 6), the following as the IP address and port number of the second terminal: the IP address and port number that are (i) included in the path-setting-request packet and (ii) of the terminal that is to receive the path-setting-request packet. The path setting unit 62 further writes, into the path information storage subunit (FIG. 6), (i) the IP address of the data transmission terminal 400 as the first relay IP address and (ii) the IP address of the first relay device 200 as the second relay IP address (Step S208).

On this occasion, the path setting unit 62 writes, into the allocated band storage unit 54 of its own device, the following as the IP address and port number of the first terminal: the IP address and port number that are (i) included in the path-setting-request packet and (ii) of the terminal that has transmitted the path-setting-request packet. The path setting unit 62 also writes, into the allocated band storage unit 54, the following as the IP address and port number of the second terminal: the IP address and port number that are (i) included in the path-setting-request packet and (ii) of the terminal that is to receive the path-setting-request packet.

After the path setting unit 62 performs the above-described processing or the like on the path-setting-request packet, the second relay device 300 transfers the path-setting-request packet to the first relay device 200 (Step S209).

The first relay device 200 receives the path-setting-request packet. In the first relay device 200, the request packet detection unit 53 detects the path-setting-request packet. The path setting unit 62 writes, into the path information storage subunit (FIG. 6) of its own device, the following as the IP address and port number of the first terminal: the IP address and port number that are (i) included in the path-setting-request packet and (ii) of the terminal that has transmitted the path-setting-request packet. The path setting unit 62 also writes, into the path information storage subunit (FIG. 6), the following as the IP address and port number of the second terminal: the IP address and port number that are (i) included in the path-setting-request packet and (ii) of the terminal that is to receive the path-setting-request packet. The path setting unit 62 further writes, into the path information storage subunit (FIG. 6), (i) the IP address of the second relay device 3000 as the first relay IP address and (ii) the IP address of the data reception terminal 100 as the second relay IP address (Step S210).

On this occasion, the path setting unit 62 writes, into the allocated band storage unit 54 of its own device, the following as the IP address and port number of the first terminal: the IP address and port number that are (i) included in the path-setting-request packet and (ii) of the terminal that has transmitted the path-setting-request packet. The path setting unit 62 also writes, into the allocated band storage unit 54, the following as the IP address and port number of the second terminal: the IP address and port number that are (i) included in the path-setting-request packet and (ii) of the terminal that is to receive the path-setting-request packet.

After the path setting unit 62 performs the above-described processing or the like on the path-setting-request packet, the first relay device 200 transfers the path-setting-request packet to the data reception terminal 100 (Step S211).

Upon receiving the path-setting-request packet, the data reception terminal 100 generates a path-setting-response packet as a response to the path-setting request packet. The generated path-setting-response packet is transferred from the data reception terminal 100 to the first relay device 200, from the first relay device 200 to the second relay device 300, and then from the second relay device 300 to the data transmission terminal 400 (Steps S212, S213 and S214).

### <<Band Reservation Processing (Case 1)>>

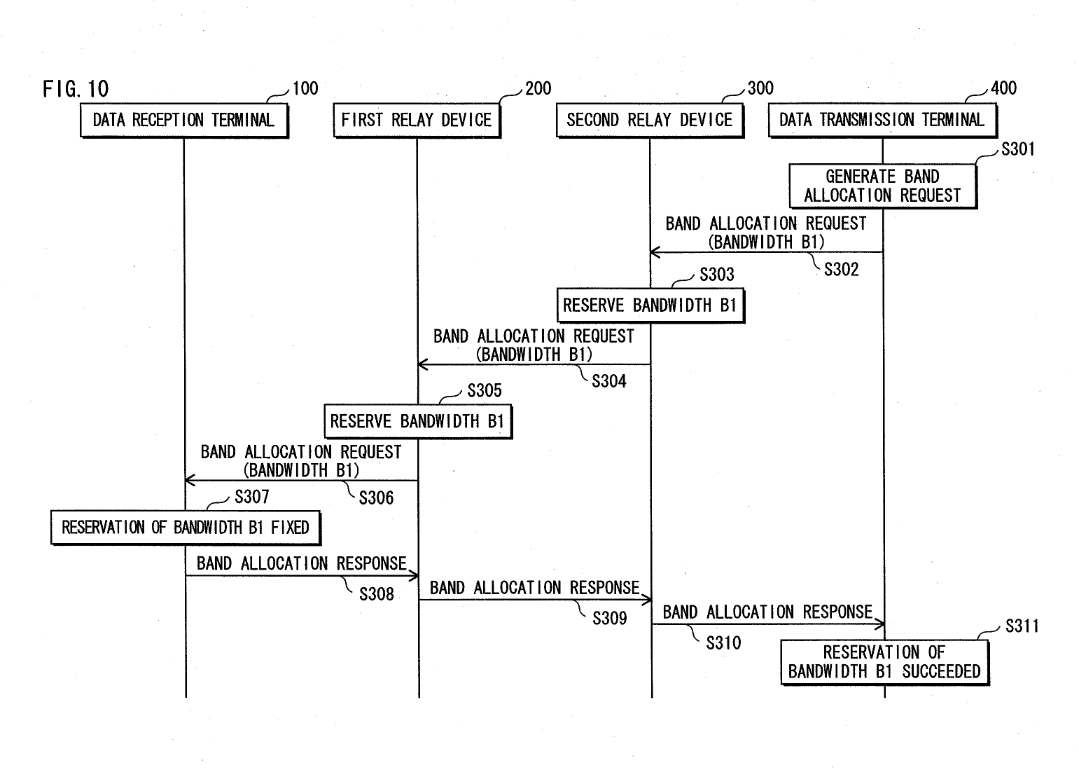

With reference to FIG. 10, the following describes band reservation processing performed in the communication system in a case where the band allocation request is made only by the data transmission terminal. FIG. 10 shows an operation sequence illustrating a flow of the band reservation processing performed in the communication system. It should be noted that FIG. 10 shows a case where the band allocation request is made on the connection (TCP connection or UDP connection) that has never been subjected to a bandwidth reservation before.

In the data transmission terminal 400, the packet generation unit 16 generates a band-allocation-request packet (Step S301). Here, this band-allocation-request packet includes the following information: (i) bandwidth B1 to request; (ii) the IP address of its own terminal; (iii) the port number of application software that makes the band allocation request; and (iv) flow information indicating DOWNSTREAM.

The data transmission terminal 400 transmits the band-allocation-request packet to the second relay device 300 (Step S302).

In the second relay device 300 that has received the band-allocation-request packet, the processing flow shown in FIG. 8 is performed. The band allocation/cancellation control unit 60 writes (i) “DOWNSTREAM” into the corresponding REQUEST FLOW INFORMATION column of the allocated band storage unit 54 of its own device, and (ii) “B1” into the corresponding BAND column of the allocated band storage unit 54 (Step S303).

With reference to the information sets stored in the path information storage subunit of its path setting unit 62, the second relay device 300 transfers the band-allocation-request packet to the first relay device 200 (Step S304).

In the first relay device 200 that has received the band-allocation-request packet, the processing flow shown in FIG. 8 is performed. The band allocation/cancellation control unit 60 writes (i) “DOWNSTREAM” into the corresponding REQUEST FLOW INFORMATION column of the allocated band storage unit 54 of its own device, and (ii) “B1” into the corresponding BAND column of the allocated band storage unit 54 (Step S305).

With reference to the information sets stored in the path information storage subunit of its path setting unit 62, the first relay device 200 transfers the band-allocation-request packet to the data reception terminal 100 (Step S306).

In the data reception terminal 100 that has received the band-allocation-request packet, the request/response processing subunit 17a (i) searches, from among the information sets stored in the flow information storage unit 12, an information set including the IP address and port number of the opposite terminal that match the IP address and port number included in the band-allocation-request packet, and (ii) writes “B1” into the BAND column of the selected information set (Step S307).

In response to the band-allocation-request packet, the request/response processing subunit 17a generates a band-allocation-response packet that includes the IP address, port number and bandwidth included in the band-allocation-request packet. The generated band-allocation-response packet is transferred from the data reception terminal 100 to the first relay device 200, from the first relay device 200 to the second relay device 300, and then from the second relay device 300 to the data transmission terminal 400 (Steps S308, S309 and S310). Here, each relay device transfers the band-allocation-response packet with reference to the information sets stored in the path information storage subunit of its path setting unit 62.

In the data transmission terminal 400 that has received the band-allocation-response packet, the request/response processing subunit 17a (i) searches, from among the information sets stored in the flow information storage unit 12, an information set including the IP address and port number of its own terminal that match the IP address and port number included in the band-allocation-request packet, and (ii) writes “B1” into the BAND column of the searched information set (Step S311).

### <<Band Reservation Processing (Case 2)>>

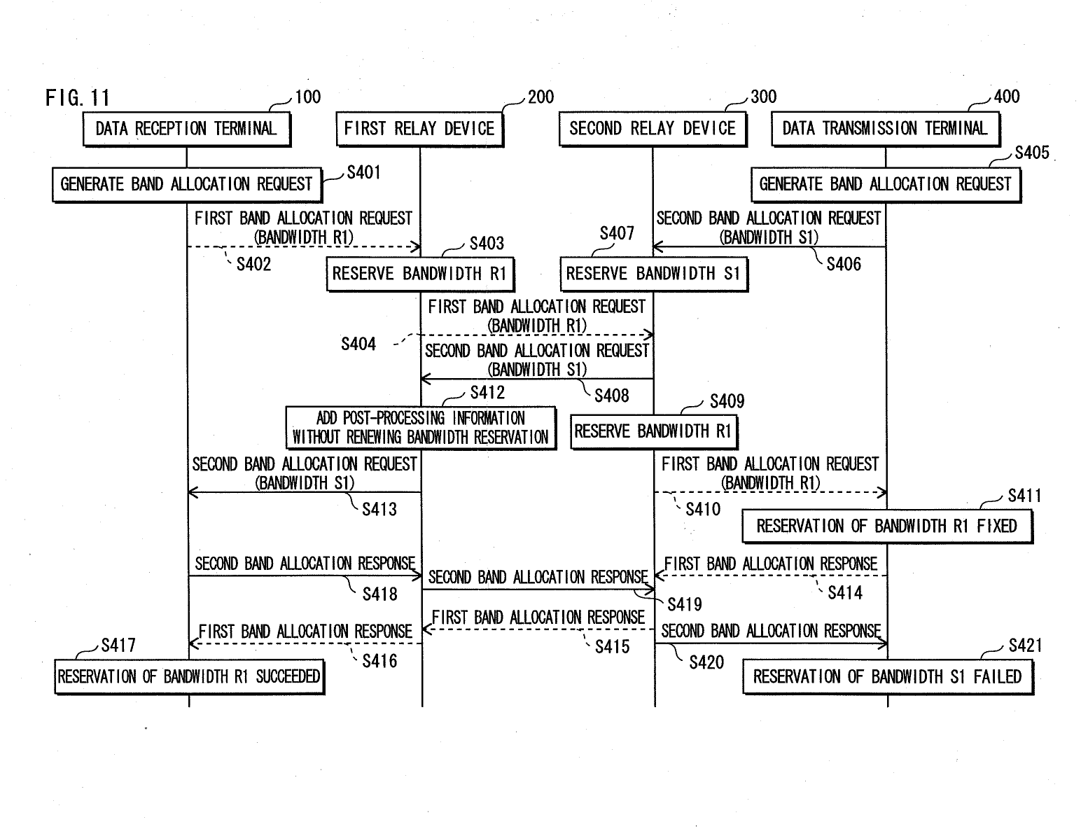

With reference to FIG. 11, the following describes band reservation processing performed in the communication system in a case where both the data transmission terminal and the data reception terminal make the band allocation request. FIG. 11 shows an operation sequence illustrating flows of band reservation processing performed in the communication system. Note that the operation sequence shown in FIG. 11 is of when the data transmission terminal 400 and the data reception terminal 100 make, almost at the same time, band allocation requests for requesting different bandwidths on the same connection. Also note that FIG. 11 shows a case where the band allocation request is made on the connection that has never been subjected to a bandwidth reservation before.

In the data reception terminal 100, the packet generation unit 16 generates a first band-allocation-request packet (Step S401). Here, the first band-allocation-request packet includes the following information: (i) bandwidth R1 to request; (ii) the IP address of its own terminal; (iii) the port number of application software that makes the band allocation request; and (iv) flow information indicating UPSTREAM.

The data reception terminal 100 transmits the first band-allocation-request packet to the first relay device 200 (Step S402).

In the first relay device that has received the first band-allocation-request packet, the processing flow shown in FIG. 8 is performed. The band allocation/cancellation control unit 60 writes (i) “UPSTREAM” into the corresponding REQUEST FLOW INFORMATION column of the allocated band storage unit of its own device, and (ii) “R1” into the corresponding BAND column of the allocated band storage unit (Step S403).

With reference to the information sets stored in the path information storage subunit of its path setting unit 62, the first relay device 200 transfers the first band-allocation-request packet to the second relay device 300 (Step S404).

In the data transmission terminal 400, the packet generation unit 16 generates a second band-allocation-request packet (Step S405). Here, the second band-allocation-request packet includes the following information: (i) bandwidth S1 to request; (ii) the IP address of its own terminal; (iii) the port number of application software that makes the band allocation request; and (iv) flow information indicating DOWNSTREAM.

The data transmission terminal 400 transmits the second band-allocation-request packet to the second relay device 300 (Step S406).

In the second relay device 300 that has received the second band-allocation-request packet, the processing flow shown in FIG. 8 is performed. The band allocation/cancellation control unit 60 writes (i) “DOWNSTREAM” into the corresponding REQUEST FLOW INFORMATION column of the allocated band storage unit 54 of its own device, and (ii) “S1” into the corresponding BAND column of the allocated band storage unit 54 (Step S407).

With reference to the information sets stored in the path information storage subunit of its path setting unit 62, the second relay device 300 transfers the second band-allocation-request packet to the first relay device 200 (Step S408).

In the second relay device 300 that has also received the first band-allocation-request packet, the processing flow shown in FIG. 8 is performed. Here, the flow information (UPSTREAM) included in the first band-allocation-request packet is given priority over the corresponding request flow information (DOWNSTREAM) stored in the allocated band storage unit 54 of its own device. Therefore, the band allocation/cancellation control unit 60 writes (i) “UPSTREAM” into the corresponding REQUEST FLOW INFORMATION column of the allocated band storage unit 54 and (ii) “R1” into the corresponding BAND column of the allocated band storage unit 54 (Step S409).

With reference to the information sets stored in the path information storage subunit of its path setting unit 62, the second relay device 300 transfers the first band-allocation-request packet to the data transmission terminal 400 (Step S410).

In the data transmission terminal 400 that has received the first band-allocation-request packet, the request/response processing subunit 17a (i) searches, from among the information sets stored in the flow information storage unit 12 of its own terminal, an information set including the IP address and port number of the opposite terminal that match the IP address and port number included in the first band-allocation-request packet, and (ii) writes “R1” into the BAND column of the searched information set (Step S411).

In the first relay device 200 that has received the second band-allocation-request packet, the processing flow shown in FIG. 8 is performed. Here, the flow information (DOWNSTREAM) included in the second band-allocation-request packet is not given priority over the corresponding request flow information (UPSTREAM) stored in the allocated band storage unit 54 of its own device. Therefore, the band allocation/cancellation control unit 60 does not reserve the bandwidth requested by the second band-allocation-request packet. Instead, the processing result adding unit 61 adds post-processing information to the second band-allocation-request packet (Step S412).

With reference to the information sets stored in the path information storage subunit of its path setting unit 62, the first relay device 200 transfers the second band-allocation-request packet, to which the post-processing information has been added, to the data reception terminal 100 (Step S413).

In the data transmission terminal 400, the request/response processing subunit 17a generates, in response to the first band-allocation-request packet, a first band-allocation-response packet that includes the IP address and port number included in the first band-allocation-request packet. The generated first band-allocation-response packet is transferred from the data transmission terminal 400 to the second relay device 300, from the second relay device 300 to the first relay device 200, and then from the first relay device 200 to the data reception terminal 100 (Steps S414, S415 and S416). Here, each relay device transfers the first band-allocation-response packet with reference to the information sets stored in the path information storage subunit of its path setting unit 62.

In the data reception terminal 100 that has received the first band-allocation-response packet, the request/response processing subunit 17a (i) searches, from among the information sets stored in the flow information storage unit of its own terminal, an information set including the IP address and port number of its own terminal that match the IP address and port number included in the band-allocation-request packet, and (ii) writes “R1” into the BAND column of the searched information set (Step S417).

In the data reception terminal 100, the request/response processing subunit 17a does not perform processing for reserving bandwidth, because the post-processing information has been added to the second band-allocation-request packet. In response to the second band-allocation-request packet, the request/response processing subunit 17a generates a second band-allocation-response packet that includes the IP address and port number included in the second band-allocation-request packet. Then, the request/response processing subunit 17a adds post-processing information to the generated second band-allocation-response packet. The second band-allocation-response packet, to which the post-processing information has been added, is transferred from the data reception terminal 100 to the first relay device 200, from the first relay device 200 to the second relay device 300, and then from the second relay device 300 to the data transmission terminal 400 (Steps S418, S419 and S420). Here, each relay device transfers the second band-allocation-response packet with reference to the information sets stored in the path information storage subunit of its path setting unit 62.

In the data transmission terminal 400 that has received the second band-allocation-response packet, the request/response processing subunit 17a acknowledges that the reservation of the bandwidth S1 has been failed, because the post-processing information has been added to the second band-allocation-response packet (Step S421).

### <<Band Reservation Processing and Band Cancellation Processing>>

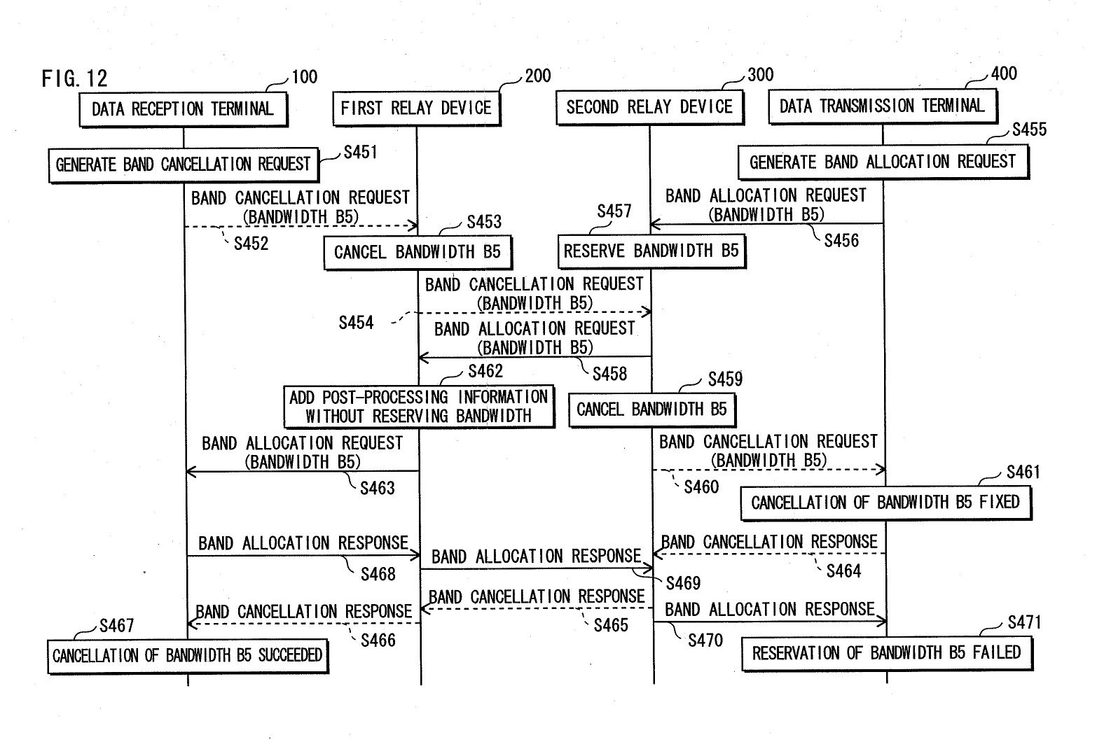

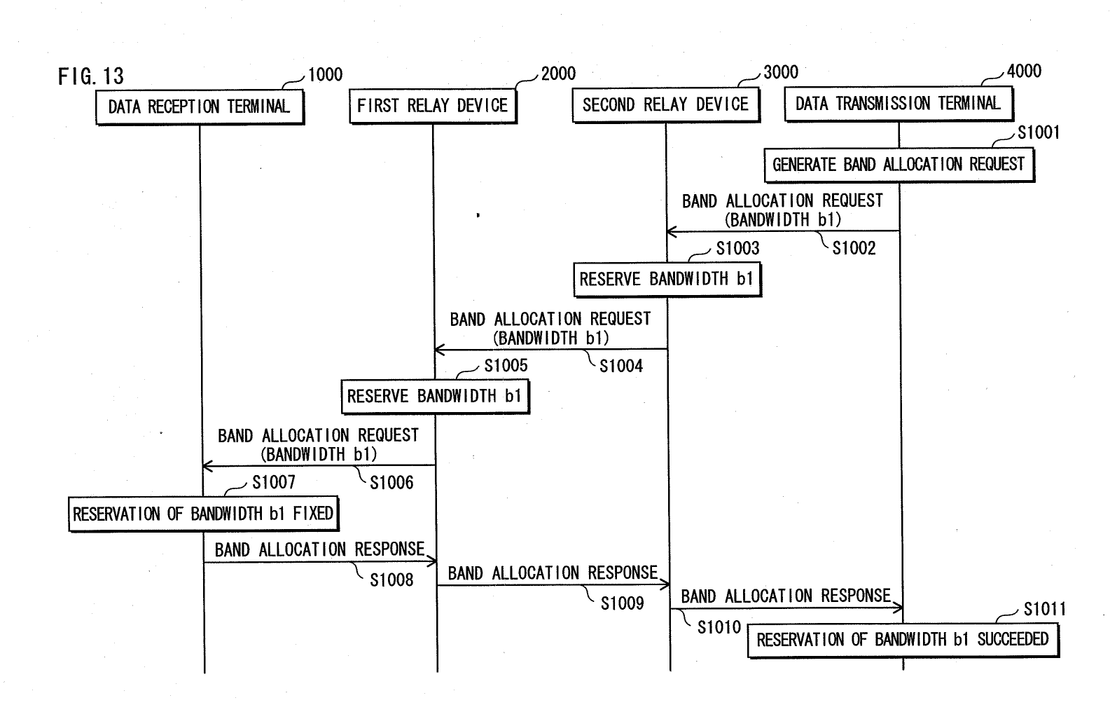

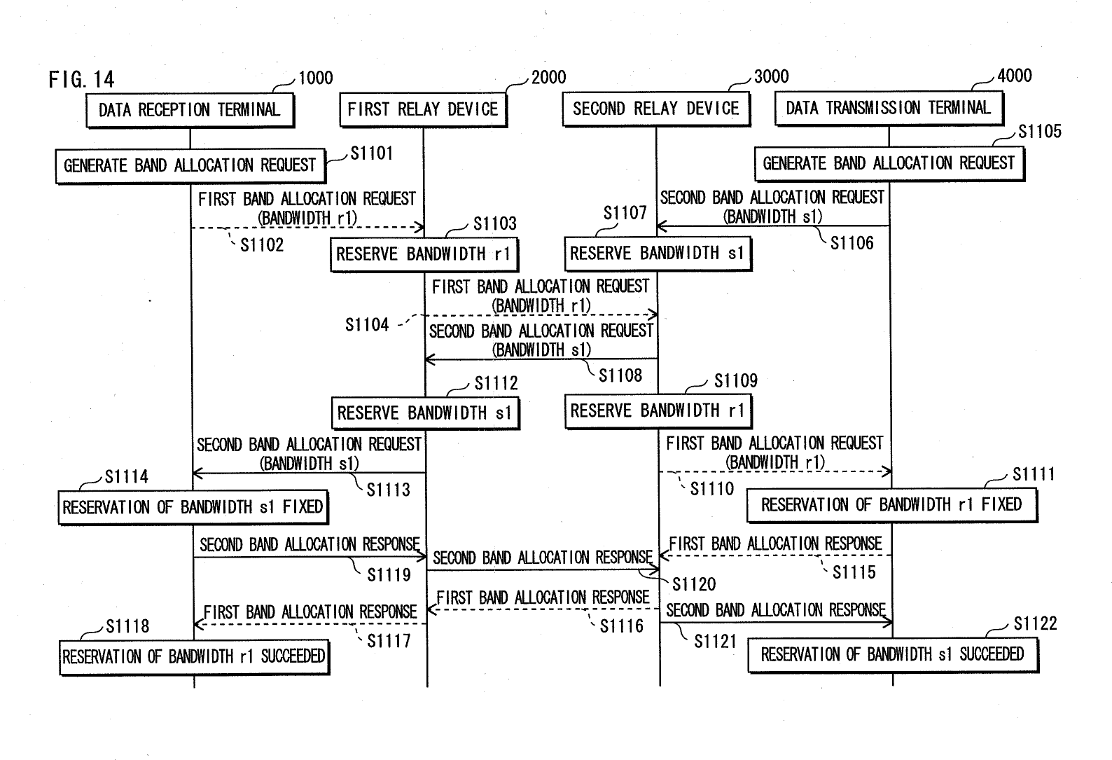

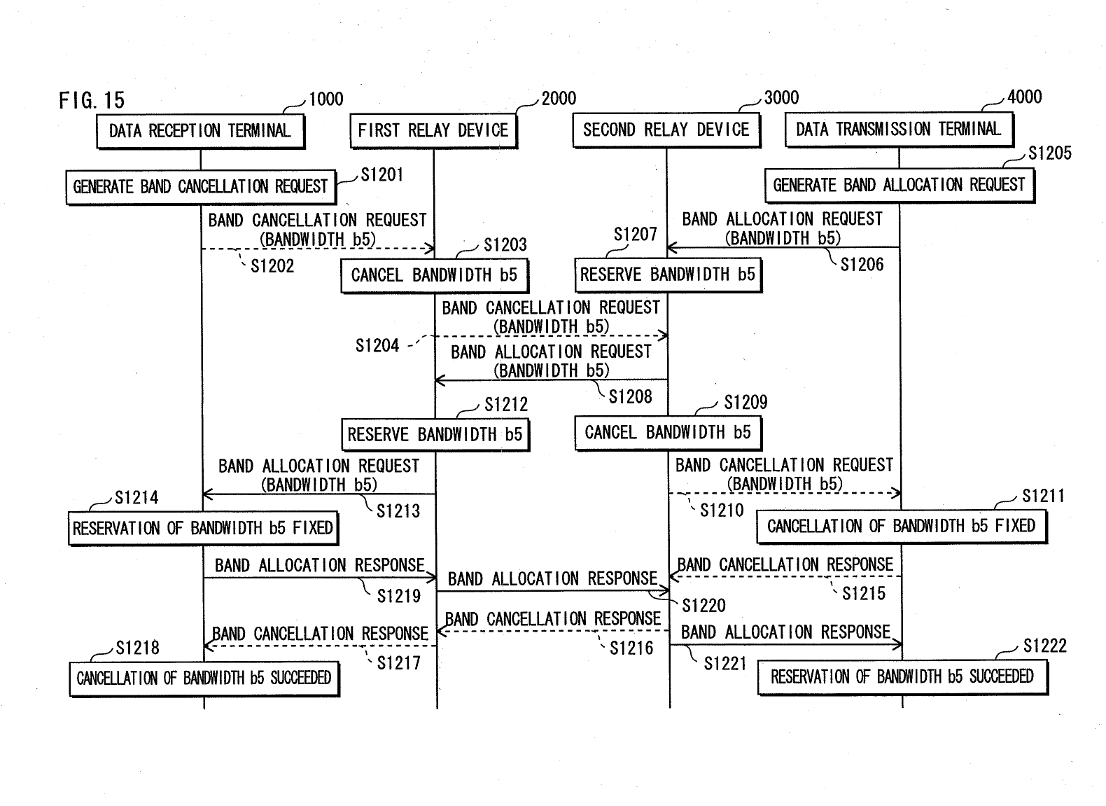

With reference to FIG. 12, the following describes band reservation processing and band cancellation processing performed in the communication system in a case where the data transmission terminal makes a band allocation request, whereas the data reception terminal makes a band cancellation request. FIG. 12 shows an operation sequence illustrating flows of the band reservation processing and the band cancellation processing performed in the communication system. Note, the operation sequence shown in FIG. 12 is of when the data transmission terminal 400 and the data reception terminal 100 respectively make, almost at the same time, a band allocation request and a band cancellation request on the same connection.

Also note that FIG. 12 shows a case where only the data transmission terminal 400 has already made a band allocation request.

In the data reception terminal 100, the packet generation unit 16 generates a band-cancellation-request packet (Step S451). Here, the band-cancellation-request packet includes the following information: (i) the IP address of its own terminal; (ii) the port number of the application software that makes the band-allocation-request; and (ii) flow information indicating UPSTREAM.

The data reception terminal 100 transmits the band-cancellation-request packet to the first relay device 200 (Step S452).

In the first relay device 200 that has received the band-cancellation-request packet, the processing flow shown in FIG. 8 is performed. Since cancellation of a bandwidth reservation is given priority over a bandwidth allocation, the band allocation/cancellation control unit 60 writes (i) “UPSTREAM” into the corresponding REQUEST FLOW INFORMATION column of the allocated band storage unit 54 of its own device, and (ii) “CANCELLED” into the corresponding BAND column of the allocated band storage unit 54 (Step S453).

With reference to the information sets stored in the path information storage subunit of its path setting unit 62, the first relay device 200 transfers the band-cancellation-request packet to the second relay device 300 (Step S454).

In the data transmission terminal 400, the packet generation unit 16 generates a band-allocation-request packet (Step S455). Here, the band-allocation-request packet includes the following information: (i) bandwidth B5 to request; (ii) the IP address of its own terminal; (iii) the port number of the application software that makes the band allocation request; and (iv) flow information indicating DOWNSTREAM.

The data transmission terminal 400 transmits the band-allocation-request packet to the second relay device 300 (Step S456).

In the second relay device 300 that has received the band-allocation-request packet, the processing flow shown in FIG. 8 is performed. The band allocation/cancellation control unit 60 writes (i) “DOWNSTREAM” into the corresponding REQUEST FLOW INFORMATION column of the allocated band storage unit 54 of its own device, and (ii) “B5” into the corresponding BAND column of the allocated band storage unit 54.

With reference to the information sets stored in the path information storage subunit of its path setting unit 62, the second relay device 300 transfers the band-allocation-request packet to the first relay device 200 (Step S458).

In the second relay device 300 that has also received the band-cancellation-request packet, the processing flow shown in FIG. 8 is performed. As cancellation of a bandwidth reservation is given priority over a bandwidth allocation, the band allocation/cancellation control unit 60 writes (i) “DOWNSTREAM” into the corresponding REQUEST FLOW INFORMATION column of the allocated band storage unit 54 of its own device, and (ii) “CANCELLED” into the corresponding BAND column of the allocated band storage unit 54 (Step S459).

With reference to the information sets stored in the path information storage information of its path setting unit 62, the second relay device 300 transfers the band-cancellation-request packet to the data transmission terminal 400 (Step S460).

In the data transmission terminal 400 that has received the band-cancellation-request packet, the request/response processing subunit 17a (i) searches, from among the information sets stored in the flow information storage unit 12 of its own terminal, an information set including the IP address and port number of the opposite terminal that match the IP address and port number included in the band-cancellation-request packet, and (ii) writes “CANCELLED” into the BAND column of the searched information set (Step S461).

In the first relay device 200 that has received the band-allocation-request packet, the processing flow shown in FIG. 8 is performed. At this moment, in the allocated band storage unit 54 of its own device, the corresponding BAND column indicates CANCELLED. Since a band cancellation request is given priority over a band reservation request, the band allocation/cancellation control unit 60 does not reserve the bandwidth requested by the band-allocation-request packet. Instead, the processing result adding unit 61 adds post-processing information to the band-allocation-request packet (Step S462).

With reference to the information sets stored in the path information storage subunit of its path setting unit 62, the first relay device 200 transfers the band-allocation-request packet, to which the post-processing information has been added, to the data reception terminal 100 (Step S463).

In the data transmission terminal 400, the request/response processing subunit 17a generates, as a response to the band-cancellation-request packet, a band-cancellation-response packet that includes the IP address and port number included in the band-cancellation-request packet. The generated band-cancellation-response packet is transferred from the data transmission terminal 400 to the second relay device 300, from the second relay device 300 to the first relay device 200, and then from the first relay device 200 to the data reception terminal 100 (Steps S464, S465 and S466). Here, each relay device transfers the band-cancellation-response packet with reference to the information sets stored in the path information storage subunit of its path setting unit 62.

In the data reception terminal 100 that has received the band-cancellation-response packet, the request/response processing subunit 17a (i) searches, from among the information sets stored in the flow information storage unit 12, an information set including the IP address and port number of its own terminal that match the IP address and port number included in the band-cancellation-response packet, and (ii) writes “CANCELLED” into the BAND column of the searched information set (Step S467).

In the data reception terminal 100, the request/response processing subunit 17a does not perform processing for reserving bandwidth, because the post-processing information has been added to the band-allocation-request packet. As a response to the band-allocation-request packet, the request/response processing subunit 17a (i) generates a band-allocation-response packet that includes the IP address and port number included in the band-allocation-request packet, and (ii) adds post-processing information to the generated band-allocation-response packet. The band-allocation-response packet, to which the post-processing information has been added, is transferred from the data reception terminal 100 to the first relay device 200, from the first relay device 200 to the second relay device 300, and then from the second relay device 300 to the data transmission terminal 400 (Steps S468, S469 and S470). Here, each relay device transfers the band-allocation-response packet with reference to the information sets stored in the path information storage subunit of its path setting unit 62.

In the data transmission terminal 400 which has received the band-allocation-response packet, the request/response processing subunit 17a acknowledges that the reservation of the bandwidth B5 has been failed, because the post-processing information has been added to the band-allocation-response packet (Step S471).

### <<Additional Remarks>>

The present invention should not be limited to the above embodiment, but may be implemented in the following manners.

(1) In the above embodiment, the bandwidth reservation or the cancellation of the bandwidth reservation is made in each connection unit (a so-called TCP connection or a so-called UDP connection). This, however, is not a limitation of the present invention. Instead, the bandwidth reservation or the cancellation of the bandwidth reservation may be made in any unit. For example, the bandwidth reservation and the cancellation of the bandwidth reservation may be made in units of a pair of the transmission terminal and the reception terminal. The port numbers are not required in this case.

(2) In the above embodiment, the IP addresses of the data transmission terminal and data reception terminal are used to identify these terminals. This, however, is not a limitation of the present invention. The IP addresses may be replaced by other information that can identify those terminals. For example, if the terminals are associated with a wireless LAN, Ethernet™, etc. and thus have MAC addresses, the MAC addresses may be used instead of the IP addresses to identify the terminals.

In the above embodiment, a pair of an IP address and a port number is used as information for identifying a path between the data transmission terminal and the data reception terminal. However, instead of the stated pair, it is permissible to use and/or combine any other information that can identify the path between the data transmission terminal and the data reception terminal.

(3) In the above embodiment, the bandwidth reservation in the DOWNSTREAM direction is given priority over the bandwidth reservation in the UPSTREAM direction. This, however, is not a limitation of the present invention. Instead, the bandwidth reservation in the UPSTREAM direction may be given priority over the bandwidth reservation in the DOWNSTREAM direction. In this case, the bandwidth reservation according to the band allocation request made by the data transmission terminal is given priority; accordingly, when there occurs a change in the transmission rate of contents or the like transmitted by the data transmission terminal, it is possible to update the bandwidth before the transmission rate actually changes.

(4) In the above embodiment, cancellation of a bandwidth reservation is given priority over a bandwidth reservation. This, however, is not a limitation of the present invention. The communication system may be configured such that whether or not to cancel a bandwidth reservation is judged using flow information.

For example, assume a case where a relay device receives a band allocation request and a band cancellation request in listed order. If flow information of the band allocation request is given priority over flow information of the band cancellation request, then the relay device does not cancel a bandwidth reservation as requested by the band cancellation request. On the other hand, if the flow information of the band cancellation request is given priority over the flow information of the band allocation request, then the relay device cancels a bandwidth reservation as requested by the band allocation request.

Contrarily, assume a case where the relay device receives the band cancellation request and the band allocation request in listed order. If the flow information of the band cancellation request is given priority over the flow information of the band allocation request, then the relay device does not make the bandwidth reservation as requested by the band allocation request. On the other hand, if the flow information of the band allocation request is given priority over the flow information of the band cancellation request, then the relay device makes the bandwidth reservation as requested by the band allocation request.

(5) In the above embodiment, whether or not to make a bandwidth reservation as requested by the band allocation request is judged using the flow information. This, however, is not a limitation of the present invention. It is permissible, for example, to judge whether or not to make the bandwidth reservation as requested by the band allocation request based on the bandwidth requested by the band allocation request. In this case, for example, bandwidth is reserved under a condition defining that a band allocation request that requests a larger bandwidth is given priority over another that requests a smaller bandwidth. Here, there may be a case where bandwidth actually reserved is larger than it was required to be. This case, however, has an advantage that the bandwidth required for data transfer is secured for sure.

(6) In the above embodiment, a bandwidth reservation is made only in a wireless interval. This, however, is not a limitation of the present invention. A bandwidth reservation may be made in a wired interval as well.

(7) In the above embodiment, the communication system is directed toward the end-to-end QoS settings. This, however, is not a limitation of the present invention. It is permissible that the bandwidth reservation or the cancellation of the band reservation is made only in a certain part of the end-to-end communications channel.

The above embodiment may be a reception method for performing processing that is equivalent to all or part of the constituents of the data transmission terminal, the data reception terminal, or the relay device.

### INDUSTRIAL APPLICABILITY

The present invention can be incorporated into QoS settings between a transmission terminal and a reception terminal.

1. A communication system including a data transmission terminal, a data reception terminal and at least one relay device that relays data communication performed between the data transmission terminal and the data reception terminal, wherein
each of the data transmission terminal and the data reception terminal transmits a request signal via a communications channel to the relay device, the request signal requesting a network resource processing that is processing associated with a network resource of a path used for the data communication, and
the relay device includes:
a judgment unit operable to judge whether or not the request signal, which has been newly received from the data transmission terminal or the data reception terminal, satisfies a condition that the newly received request signal should satisfy with respect to a prior request signal, the condition being for restraining execution of the network resource processing requested by the newly received request signal;
a restraint unit operable to, when the judgment unit judges that the newly received request signal satisfies the condition, restrain the execution of the network resource processing; and
an execution unit operable to, when the judgment unit judges that the newly received request signal does not satisfy the condition, execute the network resource processing.

2. The communication system of claim 1, wherein
the condition defines a relationship between (i) a flow direction in which the newly received request signal is transmitted and (ii) a flow direction in which the prior request signal is transmitted, each flow direction specifying one of an upstream direction and a downstream direction.

3. The communication system of claim 2, wherein
each of the data transmission terminal and the data reception terminal adds, to the request signal of own terminal, flow information indicating the flow direction of the request signal of own terminal, and
based on the flow information added to the newly received request signal, the judgment unit of the relay device judges whether or not the newly received request signal satisfies the condition.

4. The communication system of claim 1, wherein
each of the request signal and the prior request signal indicates a bandwidth to request, and
the condition defines a relationship between (i) a size of the bandwidth indicated by the newly received request signal and (ii) a size of the bandwidth indicated by the prior request signal.

5. The communication system of claim 1, wherein
the condition defines that a band-cancellation-request signal, which is a request signal requesting cancellation of a bandwidth reservation, is given priority over a band-allocation-request-signal, which is a request signal requesting allocation of the bandwidth.

6. A communication method incorporated in a communication system including a data transmission terminal, a data reception terminal and at least one relay device that relays data communication performed between the data transmission terminal and the data reception terminal, wherein
the relay device includes:
a reception unit operable to newly receive a request signal from the data transmission terminal or the data reception terminal, the request signal requesting network resource processing that is processing associated with a network resource of a path used for the data communication;
a judgment unit operable to judge whether or not the request signal newly received by the reception unit satisfies a condition that the newly received request signal should satisfy with respect to a prior request signal, the condition being for restraining execution of the network resource processing requested by the newly received request signal;
a restraint unit operable to, when the judgment unit judges that the newly received request signal satisfies the condition, restrain the execution of the network processing; and
an execution unit operable to, when the judgment unit judges that the newly received request signal does not satisfy the condition, execute the network processing.
